(19) United States
(12) Patent Application Publication
(10) Pub. No.: US 2024/0139741 A1
(43) Pub. Date: May 2, 2024

(54) MASSIVELY PARALLEL CELL ANALYSIS AND SORTING APPARATUS AND METHODS

(71) Applicant: CYTONOME/ST, LLC, Bedford, MA (US)

(72) Inventors: Johnathan Charles Sharpe, Hamilton (NZ); Pascal Spink, Medford, MA (US); Peter Kiesel, Palo Alto, CA (US)

(21) Appl. No.: 18/384,649

(22) Filed: Oct. 27, 2023

Related U.S. Application Data
(60) Provisional application No. 63/419,852, filed on Oct. 27, 2022.

(51) Int. Cl. B01L 3/00

(52) U.S. Cl. CPC B01L 3/502761; B01L 3/502776; B01L 2200/0636; B01L 2200/0652; B01L 2400/08

(57) ABSTRACT

A massively parallel microfluidic chip is provided having a plurality of sections that are stacked or layered along a stacking direction to form a plurality of microchannels at least partially oriented to flow along the stacking direction. The plurality of sections can include a transfer section for introduction of sample fluid including particles, a particle focusing section configured to focus the particles in the sample fluid, and an actuation section including a plurality of interrogation regions and a plurality of actuators. Each interrogation region and actuator is associated with at least one microchannel in the plurality of microchannels. The arrangement of the microfluidic channels along the stacking direction enables an extremely high packing density of channels and interrogation regions on a single chip to provide massively parallel processing of particles.

### CROSS REFERENCE TO RELATED APPLICATIONS

The present application claims the benefit of U.S. Provisional Patent Application No. 63/419,852, filed on Oct. 27, 2022, which is incorporated herein by reference in its entirety.

### BACKGROUND

Microfluidic devices have been used to analyze populations of particles and sort particles according to the results of the analysis. This is conventionally accomplished by flowing the particles through a region where analysis occurs such as a region where optical interrogation and detection are performed.

### SUMMARY

A microfluidic chip is disclosed. In some embodiments, the microfluidic chip includes a plurality of sections that are stacked or layered in a stacking direction to form a plurality of microchannels at least partially oriented to flow along the stacking direction. The plurality of sections includes a transfer section for introduction of sample fluid including particles. The plurality of sections includes a particle focusing section configured to focus the particles in the sample fluid. The plurality of sections includes an actuation section including a plurality of interrogation regions and a plurality of actuators. Each of the plurality of interrogation regions and each of the plurality of actuators is associated with at least one microchannel in the plurality of microchannels.

A particle processing system is disclosed. In some embodiments, the particle processing system includes a microfluidic chip having a plurality of sections that are stacked or layered in a stacking direction to form a plurality of microchannels at least partially oriented to flow along the stacking direction. The plurality of sections include a transfer section for introduction of sample fluid including particles. The plurality of sections include a particle focusing section configured to focus the particles in the sample fluid. The plurality of sections include an actuation section including a plurality of interrogation regions and a plurality of actuators. Each of the plurality of interrogation regions and each of the plurality of actuators is associated with at least one microchannel in the plurality of microchannels. In some embodiments, the particle processing system includes an electromagnetic source system to illuminate the plurality of interrogation regions. In some embodiments, the particle processing system includes a detection system to receive light from the plurality of interrogation regions. In some embodiments, the particle processing system includes a computing system operably connected to the detection system and the actuation section of the microfluidic chip. In some embodiments, the computing system is configured to control actuation of the plurality of particle deflectors based upon signals received from the detection system.

A method of assembling a microfluidic chip is disclosed. In some embodiments, the method includes aligning a transfer section with a plurality of alignment holes in a focusing section using a plurality of alignment posts. The method includes bonding the transfer section to the focusing section. The method includes aligning an actuation section to the focusing section by aligning a plurality of alignment holes in the actuation section to the alignment posts. The method includes bonding the actuation section to the focusing section.

In some embodiments, a method of sorting particles using a microfluidic chip is disclosed. The method includes flowing a sample stream including particles through a plurality of microchannels formed by a plurality of sections that are stacked or layered in a stacking direction to form the microfluidic chip. The plurality of microchannels are at least partially oriented to flow along the stacking direction. The method includes focusing particles in each of the plurality of microchannels using a focusing section of the plurality of sections. The method includes detecting particle characteristics of particles flowing through a plurality of interrogation regions in an actuation section of the plurality of sections. Each interrogation region is associated with a microchannel. The method includes sorting the particles using an actuator associated with each microchannel in response to the detected particle characteristics.

### BRIEF DESCRIPTION OF THE DRAWINGS

It is to be noted that the various features and combinations of features described below and illustrated in the figures can be arranged and/organized differently to result in embodiments which are still within the spirit and scope of the present disclosure. Further, components in the drawings are not necessarily to scale nor are they necessarily rendered proportionally, emphasis instead being placed upon clearly illustrating the relevant principles. Even further, various features may not be shown in certain figures in order to simplify the illustrations. Additionally, for the purposes of describing or showing items between layers or behind other elements or for generally simplifying the views in certain of these figures, various components or elements may be illustrated as transparent or using cross-hatching or other standard drawing techniques may be presented. To assist those of ordinary skill in the art in making and using the disclosed systems, assemblies and methods, reference is made to the appended figures.

FIG. 1 illustrates a massively parallel microfluidic chip having sections that are stacked or layered along a stacking direction in accordance with various embodiments taught herein.

FIG. 2 illustrates a cross-sectional view through a schematic representation of a microfluidic chip according to the present disclosure engaged with optical illumination and detection elements.

FIG. 3A illustrates a cross-sectional view through a schematic representation of an embodiment of a microfluidic chip engaged with optical illumination and detection elements.

FIG. 3B illustrates a top-view of the microfluidic chip of FIG. 3A.

FIG. 4A illustrates a cross-sectional view through a schematic representation of an embodiment of a microfluidic chip engaged with optical illumination and detection elements and including electrical sensor elements.

FIG. 4B illustrates a cross-sectional view through a schematic representation of an embodiment of a microfluidic chip engaged with optical illumination and detection elements wherein an interrogation region is located in a horizontal portion of the microchannel where all or a majority of fluid flows horizontally (i.e., transverse to the stacking direction).

FIG. 5 illustrates an embodiment of a microfluidic chip wherein actuators are located on or integrated within a cover layer in accordance with some embodiments taught herein.

FIG. 6 illustrates a partial cross-sectional view of the chip in FIG. 5 showing the actuator diverting particles into a branch channel.

FIGS. 7A and 7B illustrate partial cross-sectional views of a single microfluidic channel and multiple microfluidic channels, respectively, for a microfluidic chip that includes nozzles in accordance with some embodiments taught herein.

FIG. 8 illustrates separated sections of the microfluidic chip including alignment holes and alignment posts in accordance with some embodiments taught herein.

FIG. 9 illustrates the microfluidic chip having a central output channel in accordance with some embodiments taught herein.

FIGS. 10A-10B illustrate schematic views of fluidic manifolding within the microfluidic chips taught herein in accordance with various embodiments.

FIG. 11 illustrates a particle processing system including a microfluidic chip according to the present disclosure having sections stacked or layered along the stacking direction in accordance with various embodiments taught herein.

FIG. 12 illustrates a side view of the particle processing system of FIG. 11 including an electromagnetic source system, a light separation system, and a detection system in accordance with various embodiments taught herein.

FIGS. 13A-13F illustrate side views of various electromagnetic source systems in accordance with embodiments taught herein.

FIGS. 14A-14D illustrate side views of various detection systems in accordance with embodiments taught herein.

FIG. 14E illustrates an embodiment of the particle processing system wherein a single lens couples light from multiple interrogation regions to the detection system according to some embodiments taught herein.

FIG. 15 is a block diagram of a computing device suitable for use with embodiments of the present disclosure.

FIG. 16 shows a flowchart for a method of fabricating the microfluidic chip according to some embodiments taught herein.

FIG. 17 shows a flowchart for a method of processing particles using the microfluidic chip according to some embodiments taught herein.

FIG. 18A illustrates a cross-sectional view through a schematic representation of a microfluidic chip according to the present disclosure.

FIG. 18B illustrates a cross-sectional view through a schematic representation of a microfluidic chip according to the present disclosure in relation with optical illumination and detection elements.

FIGS. 18C-18E illustrate a cross-sectional view through a schematic representation of a microfluidic chip having actuator (s) at various locations according to the present disclosure.

FIG. 19A illustrates an exploded view through a schematic representation of a microfluidic chip according to the present disclosure.

FIG. 19B illustrates a top view through a three-dimensional (3D) schematic representation of a microfluidic chip according to the present disclosure.

FIG. 19C illustrates a perspective view through a 3D schematic representation of the microfluidic chip of FIG. 19B.

FIG. 19D illustrates a partial side view representation of the microfluidic chip of FIG. 19B.

FIG. 20 illustrates a stack image from a top view of stacked up sections of a fabricated microfluidic chip under operation along a stacking direction.

FIG. 21A illustrates a perspective view of a simulation for hydrodynamic focusing in a focusing region as disclosed herein.

FIG. 21B illustrates a top view of the simulation of FIG. 21A.

FIG. 21C illustrates a side view of the simulation of FIG. 21A.

FIG. 22A illustrates a schematic view of a microfluidic chip having 2×2 layout of particle processing units in accordance with various embodiments.

FIG. 22B illustrates a schematic view of a particle processing unit of FIG. 22A.

FIG. 23 illustrates an exploded view through a schematic representation of a microfluidic chip having 2×2 layout of particle processing units according to the present disclosure.

FIG. 24A illustrates a schematic view of a microfluidic chip having a main fluid path layout to feed 2×2 layout of particle processing units according to the present disclosure.

FIG. 24B illustrates a schematic view of a microfluidic chip having a main fluid path layout to feed 4×4 layout of particle processing units according to the present disclosure.

FIG. 24C illustrates a schematic view of a microfluidic chip having a main fluid path layout to feed 8×8 layout of particle processing units according to the present disclosure.

FIG. 24D illustrates a schematic view of a microfluidic chip having a main fluid path layout to feed 16×16 layout of particle processing units according to the present disclosure.

FIG. 25A illustrates a partial side view of a microfluidic chip according to the present disclosure.

FIG. 25B illustrates an isometric view of the microfluidic chip of FIG. 25A.

FIG. 25C illustrates a top view of the microfluidic chip of FIG. 25A.

FIG. 25D illustrates a bottom view of the microfluidic chip of FIG. 25A.

FIG. 26A illustrates a layout of a main fluid path of a microfluidic chip having 16×16 layout of particle processing units.

FIG. 26B illustrates a layout of measurement and actuation sections of the 16×16 layout of particle processing units of FIG. 26A.

FIG. 27A illustrates an exploded view through a schematic representation of a disc-shape microfluidic chip having m×n (m>1, n>1) layout of particle processing units according to the present disclosure.

FIG. 27B illustrates an isometric view of the ?assembled disc-shape microfluidic chip of FIG. 27A.

FIG. 27C illustrates a front view of the disc-shape microfluidic chip of FIG. 27A.

FIG. 27D illustrates a back view of the disc-shape microfluidic chip of FIG. 27A.

FIG. 27E illustrates a side view of the disc-shape microfluidic chip of FIG. 27A.

FIGS. 28A-28B illustrate various embodiments of a particle processing system for simultaneous illumination and detection according to the present disclosure.

FIG. 29A illustrates an illumination scheme at a fluidic plane of a particle processing system.

FIG. 29B illustrates a light projection scheme as imaged onto a detector plane of a particle processing system.

### DETAILED DESCRIPTION OF THE DRAWINGS

Systems and methods taught herein employ a “massively parallel” stacked design of microfluidic structures by utilizing sections in a stacked or layered relationship (i.e., one section on top of another) that combine to form a plurality of microfluidic channels oriented primarily along a stacking direction that is perpendicular to a plane defining the sections. The massively parallel microfluidic chip enables a high density of parallel particle analysis, processing, or sorting operations (or any mixture of these) to be conducted using the microfluidic chip. In particular, the use of sections that are stacked or layered along the stacking direction enables the use of non-planar microfluidic features that can be more densely packed on the chip thereby allowing a greater number of simultaneous particle operations and faster total throughput. The sections can be defined by function and operation as discussed below. In some embodiments, the sections can include multiple functions. In some embodiments, the sections can include one or more layers. In some embodiments, the one or more layers may provide different functions. For example, as described herein an actuation section can include one or more layers and the layers may be grouped to provide focusing, actuation and so on. As described below, in some embodiments a focusing section and an actuation section maybe combined into a single section and provide the function and operation of focusing and actuation in a single section, in this way the actuation section can include a plurality of focusing regions and interrogation regions.

In some embodiments of systems and methods taught herein, fluid paths are configured in such a way that they are predominantly aligned to flow in the stacking direction along a thickness of the microfluidic chip. In some embodiments, the flow direction of particles according to the present disclosure corresponds with the optical axis used by illumination or detection systems at or near the point of interrogation. In some embodiments, the flow direction of particles according to the present disclosure in an interrogation region is normal to the optical axis used by illumination or detection systems at or near the point of interrogation. In conventional systems, fluid flow is largely across a single plane (i.e., generally parallel to a longitudinal axis or a transverse axis of the microfluidic chip). Thus, despite significant efforts to reduce the cross-sectional area taken up by each collection of particle processing elements (e.g., main and branch microfluidic channels, sorting actuator, particle focusing features), conventional microfluidic chips that employ flow on-chip that is predominantly end-to-end within the plane of the chip are limited in the number of parallel sorting, processing, and analysis operations that may be performed on a single chip. In the massively parallel microfluidic chips taught herein, the third (e.g., thickness) dimension is utilized to greatly increase the density of parallel particle processing elements on a single chip while still providing the features required for successful particle sorting and processing (where channel dimensions may ultimately be the limiting factor).

In conventional systems, microfluidic chip design fluids are transported in a two-dimensional (2D) format wherein microchannels, reservoirs, mixing regions, sensing areas such as interrogation regions, focusing regions, and other regions are laid out on a single planar 2D layer. In 2D designs, the fluid is supplied to microfluidic channels in a thin microfluidic chip. The microfluidic channels are positioned (e.g., etched) within the plane of the chip such that fluid and particles flow down the length of the chip from one end of the chip to the other end along the chip's length. Each system to manipulate the particles requires space along that chip length and access to the microchannel, for example, manifold or branch regions, detection regions and sorting regions, and combining regions are located at different positions along the length of the chip. As such, the length of the chip increases as additional systems are added, and parallelizing the fluid flow by adding microchannels along a width (or transverse) direction increases the width of the chip to accommodate the extra microchannels. Historically, this design choice was driven by a number of reasons including cost, simplicity, rudimentary operation, designer mindset, ease of fabrication, desire to use a single material, and mimicking or minimizing fabrication steps. In particular, the arrangement of flow channels parallel to a plane defined by the chip has been driven by a longstanding practice of etching elongated trenches into substrates, which can often be performed using one or just a few fabrication steps and has been widely applied to glass and silicon substrates. However, the conventional 2D approach can have significant downsides such as low feature density, complicated fluid branching schemes, limited substrate functionality, low sample throughput, and limitation of various physical, chemical, or biological interfaces (e.g., thermal, optical, chemical, biological, bio-composite, mechanical, and electrical can't be done within or along a single substrate (material)).

The systems and methods taught herein improve upon conventional 2D devices (e.g., substantially planar devices where one dimension of the device such as thickness is orders of magnitude smaller than the other dimensions) by enabling the relocation of non-optical devices, fluid paths, actuators, hydrodynamic focusing elements, fluidic manifolding, and other features related to processing particles in multiple microchannels out of the highly competitive real-estate of the optical zone (i.e., a plane or planes near a top surface of the microfluidic chip that are accessible to optical interrogation and detection devices). Instead, these features and elements can be provided in sections that are stacked or layered below the optical zone in the stacking direction. Because these features are removed from the plane where optical interrogation and detection occurs, the space in the optical interrogation zone that was formerly occupied with these features and elements can be used instead for additional microchannels for particle processing. As a result, the density of particle processing features can be greatly increased using massively parallel microfluidic chips as taught herein.

Moreover, the implementation of three dimensional (3D) microfluidic structures as taught herein greatly increases microfluidic, optical, and actuation (one or a combination) feature density and greatly increases the particle throughput of such devices, for example, where the majority of fluid flow moves along or parallel to the optical axis of excitation and or detection at some point (not necessarily measurement, but minimizing the ratio). In some embodiments, fluid flow is transverse to the optical axis for the purpose of interrogation.

Systems and methods taught herein can include a density of particle processing units, particle interrogation regions, particle focusing regions, or particle sorting actuators that exceeds 1 per cm², 5 per cm², 10 per cm², 20 per cm², 50 per cm², 100 per cm², 250 per cm², or 500 per cm² in various embodiments. The systems and methods taught herein have a reduction in cross sectional area per individual particle processing unit in the viewing or imaging plane of the electromagnetic source system or the detection system. A reduction in the cross-section reduces the amount of “real estate” dedicated to or taken up by the portion of the particle processing unit that interfaces with external components such as an electromagnetic source system and a detection system. In other words, by reducing the area of the particle processing unit in the imaging plane of the electromagnetic source system, the detection system, or both to be about the size of the interrogation region or sort-monitoring region, it becomes possible to arrange more particle processing units onto a microfluidic chip substrate of a given chip size. By the same token, a desired throughput can be reached with a smaller-sized microfluidic chip as compared to a conventional microfluidic chip attempting to achieve the same levels of throughput. Another advantage of the three-dimensional stacking or layering approach is the ability to fit more particle processing units or microfluidic chips on a single wafer (or other component having a size constraint) during fabrication. This approach also can reduce the cost per device per unit area occupied. Finally, this approach can reduce the total fluidic path traversed by particles, which may improve particle outcomes such as cell viability as compared to conventional planar chip architectures, as well as overall fluid volumes required to operate the system.

As used herein, the term “massively parallel” microfluidic chip is defined as a chip that is organized such that the microfluidic channel carrying particles are oriented with a longitudinal portion positioned at least partially parallel to a height or thickness direction of the chip at a position on the chip where a particle operation occurs (e.g., particle processing, focusing, analysis, or sorting operation).

As used herein, a “planar” substrate is a material that has a first dimension (e.g., thickness) that is significantly less (e.g., at least two orders of magnitude less) than its other two dimensions (e.g., length and width).

As used herein, the term “stacking direction” refers to a direction perpendicular to planar layers or sections that form the microfluidic chip.

As used herein, the term “hydrodynamic focusing” refers to narrowing, accelerating, and positioning a sample to generate a laminar flow using sheath fluid. For example, hydrodynamic focusing is often, but not exclusively, used to position particles into the center of a microfluidic channel so that they can be reliably probed by an optical system that is focused at the center or just off-center of the channel. In some embodiments, hydrodynamic focusing is accomplished by “squeezing” a sample stream by introducing sheath fluid into a microchannel where the sample fluid is flowing. In some embodiments, hydrodynamic focusing is accomplished by narrowing a dimension of the microchannel at a position after the sample stream and sheath fluid are co-flowing using, e.g., ramps, tapers, or steps. Hydrodynamic focusing is distinguishable from sample injection (where the sample stream is introduced into a channel where sheath fluid is already flowing) because injection does not accelerate particles in the sheath fluid.

As used herein, the term “particles” includes, but is not limited to, cells (e.g., blood platelets, white blood cells, tumorous cells, embryonic cells, stem cells, spermatozoa, etc.), organelles, and multi-cellular organisms. Particles may include liposomes, proteoliposomes, yeast, bacteria, viruses, pollens, algae, or the like. Additionally, particles may include genetic material, RNA, DNA, fragments, proteins, etc. Particles may also refer to non-biological particles. For example, particles may include metals, minerals, polymeric substances, glasses, ceramics, composites, or the like. Particles may be naturally occurring or man-made. Particles may also refer to synthetic beads (e.g., polystyrene), for example, beads provided with fluorochrome conjugated antibodies. Particles may be sorted platform by sex for gender preselection in mammals, or by therapeutic or clinical value to monitor disease in humans or other animals, or in one or more drug development applications.

As used herein, the terms “microfluidic system” refers to a system or device including at least one fluidic channel having microscale dimensions. The microfluidic system may be configured to handle, process, detect, analyze, eject, and/or sort a fluid sample and/or particles within a fluid sample.

The term “channel” as used herein refers to a pathway formed in or through a medium or substrate that allows for movement of fluids, such as liquids and gases.

The term “micro channel” refers to a channel, preferably formed in a microfluidic system or device, having cross-sectional dimensions in the range between about 1.0 μm and about 2000 μm, preferably between about 25 μm and about 500 μm, and most preferably between about 50 μm and about 300 μm. One of ordinary skill in the art will be able to determine an appropriate volume and length of the micro channel for a desired application. The ranges above are intended to include the above-recited values as upper or lower limits. In general, a micro channel may have any selected cross-sectional shape, for example, U-shaped, D-shaped, rectangular, triangular, elliptical/oval, circular, square, trapezoidal, etc. cross-sectional geometries. The geometry may be constant or may vary along the length of the micro channel. Further, a micro channel may have any selected arrangement or configuration, including linear, non-linear, merging, branching, looped, twisting, stepped, etc. configurations. A microfluidic system or device, for example, a microfluidic chip, or chip substrate stack, may include any suitable number of micro channels for transporting fluids. A microfluidic chip may be provided as part of a disposable cartridge for removable engagement with a microfluidic instrument. Further, a microfluidic chip may be provided as part of a disposable cartridge, wherein the disposable cartridge is a completely enclosed and sealed or sealable fluidic channel system. Further yet, a microfluidic chip or portions of the chip may be removable, replaceable, and or irreversibly bonded/fused.

As used herein, a “particle processing unit” is a unit that includes features for performing a particle processing function (such as particle sorting) and can be replicated multiple times across a chip to increase total parallel processing throughput. Such features can include fluid focusing elements, interrogation regions, sorters or sorting actuators, and microfluidic channels for fluid or particle input or output. In some examples below, the “particle processing unit” includes a microfluidic input channel (which may receive fluid from a pool or from an inlet that feeds channels in numerous units), at least two microfluidic output channels (which may deliver sorted or processed particles and waste particles to pools or outlets that are fed to or from numerous units), an interrogation region, and an associated actuator. As described in greater detail below, microfluidic chips as taught herein include multiple particle processing units that operate in parallel. By including N number of particle processing units on a single microfluidic chip, the total throughput of particles that can be processed by the chip is increased at least N-fold.

As used herein, “interrogation” refers to probing a particle to determine the characteristics of the particle and, in some cases, the class, type, or identity of the particle. In the case of an optical system, interrogation includes detection of light emitted or otherwise scattered from an illuminated particle, or the absence of light due to interaction with a particle, to determine values for one more particle characteristics such as size, shape, form, orientation, fluorescence intensity or wavelength, optical scattering intensity or wavelength, geometry, volume, surface area, ellipticity, refractive index, granularity, porosity, conductivity, identity, type, phenotype, protein or molecular expression, genetic content, live/dead state, velocity, or the like.

As used herein, “processing” a particle refers to taking an action in response to a determination of one or more particle characteristics of the particle including, but not limited to, activating an actuator to sort the particle, isolating a particle population, purifying a particle population, enriching a particle population, optically tweezing a particle (for example, a cell), or zapping (i.e., damaging, maiming, incapacitating, or killing) a particle.

Generally, this disclosure relates to the measurement and sorting of particles, droplets, and/or fluids in a microfluidic device. More particularly, this disclosure relates to manipulation of particles, droplets, and/or fluids in a microfluidic device in a massively parallel fashion through the integration of new device apparatus designs and methods. Such manipulation may include zapping or altering the particles, droplets, and/or fluids. Such manipulation may be as a result interrogation of the particles. Such manipulation may include elongation, bonding, or other alteration of the physical, chemical, or biological properties of a particle.

Particle separation is of great interest to many biological and biomedical applications. As demand grows for sorted or analyzed particle populations for biomedical applications, the need arises to increase processing throughput to provide the ability to process more samples more quickly. Various approaches have been attempted including placing multiple channels and sorters onto a single planar microfluidic chip. Conventionally, particle operations are performed on particles in the flow channel as they flow in-plane, for example, the direction of in-plane fluid flow in a conventional microfluidic channel is in a plane largely perpendicular to an optical detection axis passing through the chip.

Microfluidic chips and associated systems taught herein are capable of analyzing, processing and/or selecting particles based on intrinsic characteristics as determined, for example, by interaction of electromagnetic radiation or light with the particles (e.g., scatter (forward, back, or side), reflection, and/or auto fluorescence) independent of protocols and necessary reagents. According to some embodiments, the microfluidic system employs a closed, sterile, disposable cartridge including a microfluidic chip such that all surfaces that come into contact with sample fluid are isolated from the user and/or from the non-disposable instrument. The microfluidic system analyzes and/or processes particles at high speeds. A microfluidic sorting system using a microfluidic chip 100 as taught herein delivers sorted particles with high yield, high purity, high enrichment, and high efficacy or other predefined/desired population attributes.

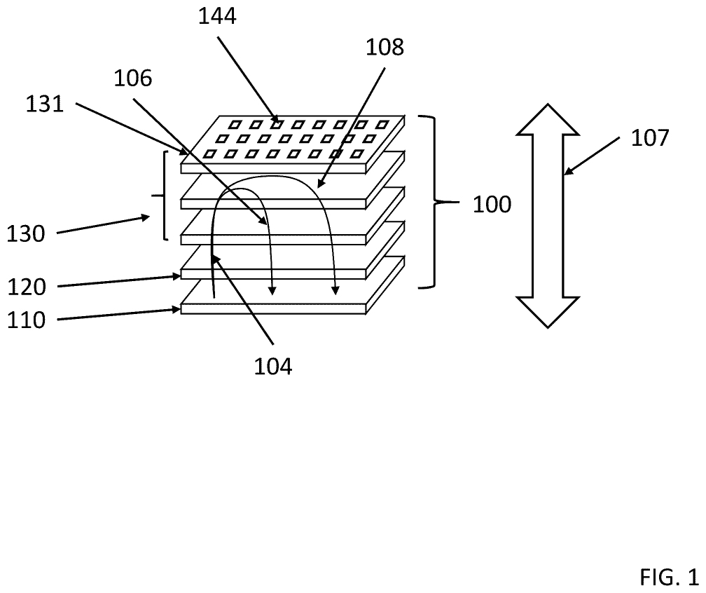

FIG. 1 illustrates a schematic exploded view of a massively parallel microfluidic chip 100 in accordance with various embodiments taught herein. The massively parallel microfluidic chip 100 includes a number of sections that stack to form the chip 100. The microfluidic chip 100 can include a transfer section 110, a particle focusing section 120, and an actuation section 130 that includes a cover layer 131. Each of the transfer section 110, the particle focusing section 120, and the actuation section 130 can be formed of a single material layer or of multiple material layers. One of ordinary skill in the art would recognize that some or all of the sections maybe formed by additive manufacturing, lithography, bonding, or molding, or some or all of the sections may be formed individually and later assembled into the microfluidic chip 100. The sections of the microfluidic chip are stacked or layered in a stacking direction 107 (i.e., thickness of the microfluidic chip). When the sections of the chip 100 are stacked or layered, multiple fluidic microchannels are formed through one or more of the sections that are predominantly oriented to enable flow along the stacking direction 107. The multiple microfluidic channels and related particle processing elements form particle processing units that are arranged in a pattern 144.

Fluid including particles is introduced into a microchannel from among the multiple microchannels in the transfer section 110. Some embodiments may not include a transfer section. The fluid including particles flows upward or downward depending on the stacking direction (i.e., from the transfer section to or through the particle focusing section) in the microchannel along a fluid input path 104 through the sections that are stacked or layered. The particles are focused in the particle focusing section 120 and pass into the actuation section 130. The actuation section 130 can separate desired particles from undesired particles based upon measured particle characteristics. In some embodiments, the actuation section 130 includes an interrogation section or region. In some embodiments, an interrogation section is a separate distinction section from the actuation section 130. The desired particles flow back downwards or upwards depending on the stacking direction (i.e., back toward the transfer section 110) through the stacked or layered sections in a microchannel along a first output path 106 (sometimes referred to as a “keep” path). The undesired particles flow back downwards or upwards depending on the stacking direction (i.e., back toward the transfer section 110) through the stacked or layered sections in a microchannel along a second output path 108 (sometimes referred to as a “waste” path). Particles in the first output path 106 and the second output path 108 can separately be extracted from the chip 100 at the transfer section 110.

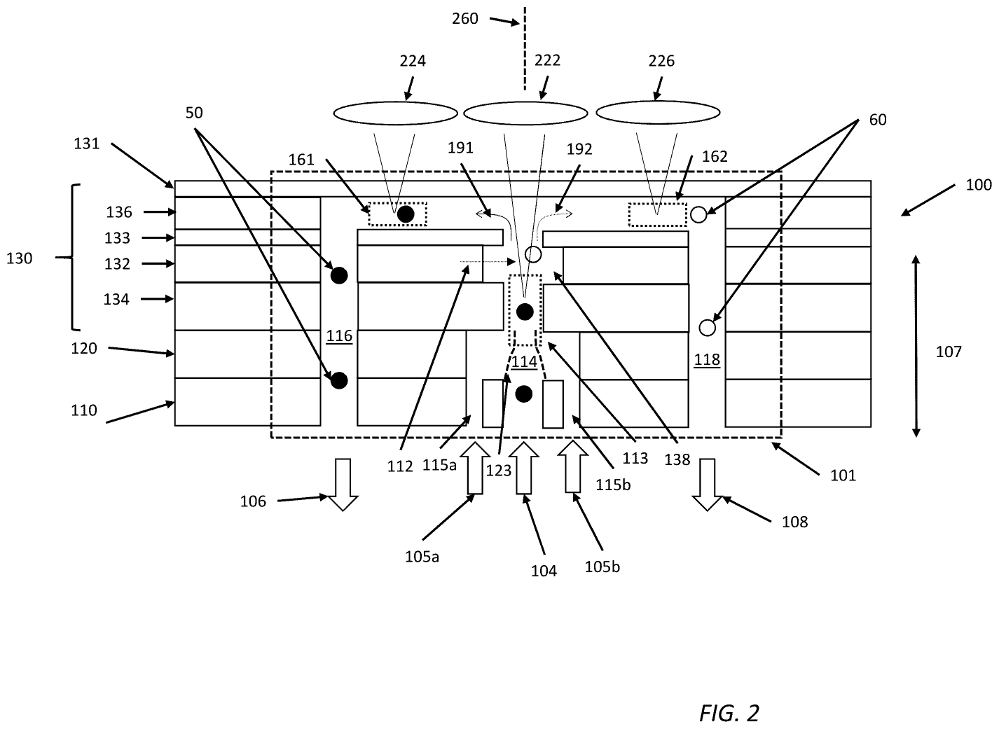

The cross-sectional view of FIG. 2 facilitates description of the features of the massively parallel microfluidic chip 100 according to some embodiments. FIG. 2 illustrates a cross-sectional view through a schematic representation of the microfluidic chip 100 during engagement with optical illumination/detection elements and with fluid and particles flowing therein. FIG. 2 illustrates a single particle processing unit 101 as taught herein to facilitate explanation. However, the microfluidic chip 100 includes between 10 and 1000 particle processing units 101 as described with respect to FIG. 2. In the particle processing unit 101, one or more sample fluid input paths 104 can be joined by one or more sheath fluid input paths 105a, 105b to surround the sample fluid with sheath fluid and, in some embodiments, focus the sample fluid. For example, sample fluid is injected into a main microchannel 114 through the transfer section 110 while sheath fluid on sheath fluid input paths 105a, 105b is injected into respective sheath channels 115a, 115b through the transfer section 110. The sheath channels 115a, 115b intersect the main microchannel 114 in the focusing section 120 wherein sheath fluid comes into contact with sample fluid. In some embodiments that do not use sheath fluid, there are no sheath fluid input paths 105 and sample fluid alone flows on sample fluid input path 104 through microchannel 114. Sheath fluid and sample fluid that includes particles 50, 60 meet in the microchannel 114 at the particle focusing region 123 of the particle focusing section 120. The particle focusing region 123 is where the sheath fluid acts to focus the particles 50, 60 as indicated by streamlines in the particle focusing region 123 that show compression of sample fluid by sheath fluid in the region of fluid intersection. Particles 50, 60 then pass into an interrogation region 113 in the actuation section 130. Each particle 50, 60 can be interrogated by light that is directed by a lens 222 through the cover section 131 and onto the particle. The light is emitted, scattered, absorbed, or extinguished by the particle according to characteristics of the particle. Detection of the emitted or scattered light, or a change in the level of existing light, through the lens 222 enables identification of the particle characteristics. For example, particular characteristics of the particles such as size, form, fluorescence, optical scattering, and other characteristics can be identified by detecting the emitted or scattered light or a change in level of existing light (e.g., extinction). Based upon identification of the particle characteristics, an actuator 112 of the actuation section 130 can actuate to cause the desired particle 60 (i.e., particle that possesses the desired characteristic) or the undesired particle 50 (i.e., particle that does not possess the desired characteristic) to deviate from a normal flow path 191 and onto a diverted flow path 192. In FIG. 2, the particles 60 that are subject to action from the actuator 112 flow on the diverted flow path 192 through microchannel 118 on the second output path 108 while particles that are not acted upon by the actuator 112 flow through microchannel 116 on the first output path 106. In some embodiments, the results of sorting (i.e., the results of actuation) can be monitored as particles pass through a first sort monitoring region 161 in the first output flow path 106 by lens 224 or as particles pass through a second sort monitoring region 162 in the second output flow path 108 by lens 226. Light that is emitted from particles through lenses 224 and 226 can pass through the cover section 131 and be detected to verify whether the sort occurred as expected.

While lenses 222, 224, 226 are depicted to aid in explanation of the features of the microfluidic chip 100, it is understood that the lenses are part of a particle processing system separate from the microfluidic chip and are not a feature to the microfluidic chip. In other embodiments, cover section 131 of the chip may include integrated optical features such as a lenticular array, meta lens array, or other optical characteristics configured to simplify alignment and or optical and chip design. An integrated optical feature may be a molded element that makes up the cover section 131 made from glass or plastic, as a non-limiting example. Embodiments of particle processing systems for use with the microfluidic chip 100 taught herein are described in greater detail below starting from the description of FIG. 6. In some embodiments, the individual lenses 222, 224, 226 can be a single unit in an array of lenses or microlenses.

The transfer section 110 can transport fluids into and out of the multiple microfluidic channels in the microfluidic chip 100. The transfer section 110 can include inlet ports to enable introduction of fluids into the microfluidic chip. For example, the transfer section 110 can include an inlet port for introduction of sample fluid including particles for processing or sorting. The transfer section 110 can also include one or more inlet ports for introduction of sheath fluid to be used in modifying the sample fluid stream, e.g., for focusing particles. The transfer section 110 can also include one or more outlet ports for extraction of fluids and particles from the microfluidic chip 100. In one embodiment, a first outlet port enables extraction of “keep” path particles and fluid while a second outlet port enables extraction of “waste” path particles. The transfer section 110 can include one or more manifolds to distribute fluid from the ports to one or more microchannels within the microfluidic chip. For example, a sample inlet manifold can distribute sample fluid to each of the multiple microfluidic channels. Similarly, a sheath inlet manifold can distribute sheath fluid to each of the multiple microfluidic channels. In some embodiments, manifolds can perform aggregation of targeted or non-targeted particles from multiple microfluidic channels by combining and porting the outputs from a number of output paths into a single flow through an outlet port. For example, manifolds of the transfer section 110 can combine fluid from all of the first output paths 106 or fluid from all of the second output paths 108 for extraction from the chip 100.

In some embodiments, the transfer section 110 can include one or more filters. The filters can ensure that large particles, debris, particle aggregates, and other large items do not enter the microfluidic chip 100. Large items can lead to undesired effects such as blockages in the microfluidic channels or measurement and sorting inaccuracies, among other issues.

The particle focusing section 120 can entrain (e.g., focus, align, separate, stabilize, orient, etc.) particles upstream of the interrogation region 113 in order to optimize or enhance the particle interrogation process. In particular, the particle focusing section 120 can enable focusing of the particles in the microfluidic channel 114. Focusing of the particles results in particles that are fluidically well behaved; that travel in single file; that are confined to a defined region of the microfluidic channel (e.g., a central fluidic core); that are spaced randomly or spread evenly so that the particles can be reliably measured and accurately sorted; or any combination of the above. Focusing can be achieved using a variety of techniques. In one example, hydrodynamic focusing can be achieved by changes in the geometry of the microfluidic channel 114 such as ramps or tapers that constrict the fluidic volume and accelerate and narrow the stream in the channel. Alternatively or in addition, sheath fluid can be injected into the microfluidic channel 114 via sheath channels 115a, 115b that intersect with the microfluidic channel 114. The sheath channels 115a, 115b can be placed on opposite sides of the microchannel 114 to create countervailing forces at the same intersection point. In other embodiments, the intersection points of different sheath fluid channels 115a, 115b with the microfluidic channel 114 can occur at different longitudinal locations along a length of the microfluidic channel. As shown in FIG. 2, the sheath channels can be flow parallel to the microfluidic channel 114. However, the sheath channels can also flow to the intersection(s) with the microfluidic channel 114 from a perpendicular direction or from any angle, and it should be appreciated that additional sheath fluid channels can flow in adjacent planes not shown in the cross-sectional view of FIG. 2 (i.e. the sheath channels can be “behind” or “in front of” the microfluidic channel 114 shown in the cross-sectional plane of FIG. 2).

Sheath fluid can be used as a transportation fluid to reduce blockages in some embodiments. Sheath fluid can be used to mechanically or chemically influence particles in the microfluidic channel 114 including though biochemical interactions of sheath fluid components with the particles. The sheath fluid can be used to wash, dilute, singulate, align, orient, bias the direction of, speed up, slow down, or center particles in the sample fluid in various embodiments.

The particle focusing section 120 can also employ technologies as an alternative to hydrodynamic technologies for particle focusing including acoustic wave (including surface acoustic wave), electrophoretic, magnetic, optical, or other technologies. The surface acoustic wave can be generated using an interdigitated transducer (IDT) located on or within a layer of the particle focusing section 120. In embodiments that do not employ hydrodynamic focusing, the sheath fluid may be reduced in volume or eliminated completely as being unnecessary. In some embodiments, alternative focusing technologies can be used together or in conjunction with hydrodynamic focusing. In some embodiments, passive particle focusing methods can be used that rely upon structural changes to the microfluidic channel. For example, Dean inertial flow techniques can be employed in the particle focusing section 120 to focus particles including spirals or serpentines in the flow channel. In some embodiments, the particle focusing section 120 can ensure reliable singulation of cells (i.e., positioning of cells in “single file” along the length of the microfluidic channel) to enable accurate or reproducible measurement of particle properties using, e.g., optical measurement. The particle focusing section 120 can space cells using hydrodynamic methods, mechanical methods such as acoustic forces, or optical methods such as optical tweezing.

In some embodiments, the particles may not be focused entirely within the particle focusing section 120. Some focusing of the particles can occur at or within boundary or junction areas between sections, for example. In particular, hydrodynamic forces and effects may not be discretely maintained within a single section but may extend downstream to some degree such that focusing effects can still be said to occur after the particles have exited the particle focusing section 120.

The actuation section 130 includes an actuator 112 associated with one or more of the microfluidic channels 114 that are downstream of interrogation regions 113 associated with one or more of the microfluidic channels 114. To facilitate explanation, a single actuator 112 in association with the microfluidic channel 114 is illustrated and described. However, the microfluidic chip 100 includes between 10 and 2000 actuators 112 as described with respect to FIG. 2 and other figures disclosed herein. Those skilled in the art will appreciate that each particle processing unit 101 includes or is associated with at least one actuator 112. The actuation section 130 provides a suitable means to deflect target particles, non-target particles, or both target and non-target particles into one or more separate fluidic paths 116, 118 downstream of the actuator 112. The target or non-target particles characteristics can be directed, deflected, switched etc. to the selected flow path 106, 108. In some embodiments, the process of directing particles to the selected flow path 106, 108 can be performed on a particle-by-particle basis. The actuator 112 can use any from among a range of technologies to achieve separation of targeted particles from non-targeted particles. The range of technologies includes, but is not limited to, forces that are mechanical, optical, chemical, thermal, bubble-based, dielectrophoretic, piezoelectric, acoustic, acoustic wave-based, magnetic, valve-based, or membrane-based. One or more layers of the actuation section 130 can be formed at least partially of lithium niobate (LiNbO₃), lithium tantalite, lead zirconium titanate (LZT), zinc oxide (ZnO), aluminum nitride, quartz, polyvinylidene fluoride (PVdF), or another piezoelectric material. The piezoelectric layers can be formed as a thin film atop a different layer in some embodiments.

In some embodiments, the actuation section 130 can be formed from individual layers. The actuation section 130 can include an actuator layer 132 that includes the one or more actuators 112 formed therein or thereon. For example, acoustic wave actuators can be formed on the actuator layer 132 using conventional cleanroom etching and deposition techniques. The actuator layer 132 can be sandwiched between adjacent layers 133, 134 in some embodiments. In some embodiments, the adjacent layers 133, 134 can help to guide acoustic waves to the microchannel 114, for example. The actuator section 130 can include a processed particle layer 136 just below the cover layer 131. The processed particle layer 136 can have the lateral (i.e., flowing perpendicular to the stacking direction 107) portions of the output channels 116, 118 etched therein. In some embodiments, the actuator section 130 does not include the fluid distribution layer. In such embodiments, the processed particle layer 136 is considered a section distinct from the actuation section.

In some embodiments, the actuators 112 in the actuation section 130 can include switching surface acoustic wave actuators. The acoustic wave actuators (such as an interdigital transducer or IDT) can connect with acoustic wave generators to generate acoustic energy that is coupled into the microfluidic channel 114 to divert particles into a chosen exit stream or channel. The IDT actuator can be configured to generate a traveling or streaming surface acoustic wave (TSAW) or pressure pulse in the fluid of the microfluidic channel 114. This pressure pulse may be used to drive a slug of fluid into a selected region or direction of the microfluidic channel 114 or into a chosen output channel 116, 118. Alternatively, a pair of IDTs may be provided, one on either side of the microfluidic channel 114 at the switching site. Examples of surface acoustic wave generators, IDTs, actuators, and arrangements of these elements with respect to microchannels that are suitable for use with the present invention are described in greater detail in U.S. Pat. No. 10,646,870, entitled “MICROFLUIDIC DEVICE AND SYSTEM USING ACOUSTIC MANIPULATION” and issued May 12, 2020, the entire contents of this patent being incorporated herein by reference.

The actuation section 130 can include one or more pressure pulse channels 138 in some embodiments. The pressure pulse channel 138 such as a fluidic buffer area can be located opposite the actuator 112 in the microfluidic channel 114 to cushion or reduce the effects of a pressure pulse from the actuator 112. In turn, this absorbing of the pulse can reduce perturbations experienced by the fluid flowing within the microfluidic channel 114 and can allow for faster re-establishment of laminar flow and thus enables faster switching times. In some embodiments, the actuation section 130 can include acoustic attenuation elements positioned between adjacent particle processing units 101. The acoustic attenuation elements can absorb or reduce acoustic energy from the actuator 112 in a first particle processing unit 101 so that this energy does not disrupt or impact fluid flow in a different particle processing unit 101. In this way, the acoustic attenuation elements can acoustically isolate actuators in different particle processing units 101 on a same microfluidic chip. In some embodiments, the attenuation elements can include an air gap.

In some embodiments, the cover layer 131 of the actuation section 130 can include an optical interface layer. The cover layer 131 can enable observation, detection, or both observation and detection of particles flowing within the device. The cover layer 131 can include a window or window-like layer in some embodiments to provide a transparent optical interface to the fluid that lies below the cover layer 131. The cover layer 131 can act as a liquid-proof barrier, i.e., the cover layer 131 can prevent the movement of water or oil or other liquid from inside the chip 100 to outside or vice versa. In some embodiments, the cover layer 131 can form a portion of one or more fluidic channel pathways in which fluid flows. Other features such as electrodes may also be applied to, integrated into, or included on the cover layer 131. The cover layer 131 can include the actuator 112 in some embodiments as described in greater detail below. The cover layer 131 can be formed of one or more materials, such as glass or plastic, that are configured to provide high transmission of wavelengths of electromagnetic radiation that are of interest to a particular application (e.g., wavelengths of excitation light, scattered light, or fluorescence). In an example embodiment, the cover layer 131 can allow transmission of light at wavelengths in a range from the ultraviolet (UV) to near infrared (IR) wavelengths or for a range that represents a sub-portion of the range from UV to near-IR depending on design intent. In some embodiments, cover section 131 may include integrated optical features such as a lenticular array, meta lens array, or other optical characteristics configured to simplify alignment and or optical and chip design. An integrated optical feature may be a molded element that makes up the cover section 131 made from glass or plastic, as a non-limiting example.

In some embodiments, a total thickness of the massively parallel microfluidic chip 100 can be in a range of 0.5 to 10 mm. In some embodiments, a thickness of an individual section (i.e., the transfer section 110, particle focusing section 120, or actuation section 130) can be in a range of 10 to 1000 micrometers.

In the embodiments illustrated in FIGS. 2-4B, desired particles 60 are diverted by the action of the actuator 112. However, it is to be understood that the system can act to divert undesired particles 50 while leaving desired particles 60 largely undisturbed. Such activity is termed “anti-sorting,” and additional description and embodiments of particle processing systems and chips that utilize anti-sorting in a manner compatible with the present teachings can be found in U.S. patent application Ser. No. 17/723,236, filed Apr. 18, 2022, the entire contents of which is incorporated herein by reference. In some embodiments, undesired particles 50 may be modified, for example physically, thermally, or chemically, to damage or destroy the undesired particles 50. Modification may be employed instead of, or in addition to, physical isolation of the undesired particles 50 from the desired particles 60.

Within the chip stack, and in some embodiments, particles may flow toward (or away from) an imaging system (e.g., parallel or anti-parallel along an optical axis 260 of the imaging system). In some embodiments, the interrogation region 113 and the actuator 112 are both located in the actuation section 130. In some embodiments, the actuator 112 can operate within the interrogation region 113. It should be understood that the interrogation region 113 and the actuator 112 can be positioned at different points in the chip stack or in different sections or layers. Moreover, flow and measurement of particles using the microfluidic chip 100 taught herein is not restricted to a direction toward or away from the imaging system but could occur along another path, for example, a horizontal flow path.

The pattern 144 of particle processing units 101 within the microfluidic chip 100 can be selected to optimize functionality within the microfluidic chip 100. For example, the pattern 144 can be configured to reduce or minimize the total flow path of all fluid (or a subset of fluid such as only sample fluid or only sheath fluid) through some or all of the microchannels in the chip 100. Other examples include optimizing around mechanical designs or constraints, isolation or placement of electrical elements (such as surface acoustic wave generators), thermal isolation, avoidance of cross-talk whether mechanical, optical, electrical, or thermal, and avoidance of interference. In some embodiments, the pattern 144 of particle processing units 101 can be selected to match an arrangement of optical elements such as for a particular excitation source spacing (e.g., an array of laser beams) or detector spacing. For example, the excitation source can be a vertical-cavity surface-emitting laser (VCSEL) that outputs a square grid array of laser beams. In various embodiments, the pattern 144 can be triangular, square, rectangular, hexagonal (e.g., corresponding to a maximum packing density metric), random, two-dimensional, axisymmetric grid, radial, concentric, other interspersed polygon, or crystalline. In some embodiments, the geometrical design of the microfluidic chip 100 including the arrangement of the pattern 144 or the elements of each particle processing unit 101 can be selected to reduce autofluorescence from the particles or from other materials in the environment including the materials and structures in the microfluidic chip 100 itself. In some embodiments, spatial filtering methods can be used in the detection system 220 as described below.

In some embodiments, a density of interrogation regions 113, sort monitoring regions 161/162, particle focusing regions 123, or particle sorting regions (i.e., actuators 112) in the pattern 144 is in a range from 1 per cm² to 500 per cm². In some embodiments, the systems and methods taught herein include a small area of the chip occupied by each individual particle processing unit as viewed or imaged by an electromagnetic source system 210 or a detection system 220. A reduction in the cross-section reduces the amount of “real estate” dedicated to or taken up by the portion of the particle processing unit that interfaces with external components such as the electromagnetic source system 210 and the detection system 220. In other words, by reducing the area of the particle processing unit 101 in the imaging plane of the electromagnetic source system 210, the detection system 220, or both to be about the size of the interrogation region 113 or sort-monitoring region 161/162, it becomes possible to arrange more particle processing units onto a microfluidic chip substrate of a given size. In some embodiments, the number of interrogation regions 113, sort monitoring regions 161/162, particle focusing regions 123, or particle sorting regions on a single microfluidic chip can be in a range of 100-1000, 100-500, 250-750, 500-750, or 500-1000.

In some embodiments, a channel geometry of the microfluidic channel 114 can change over the course of the channel to create desired impacts on the particles flowing within or to reduce the effect of undesirable impacts. For example, one or more of a width, a height, a cross-section, or other measurable parameters can change over the course of the channel 114 to affect particle velocity, alignment/orientation particle positioning, particle concentration or dilution, temperature control, pressure, changes in flow direction, enabling exposure to chemicals, enabling exposure to light, enabling electrical conductance or impedance measurements, or providing a sort monitoring layer.

A location of the interrogation region 113 in the actuation section 130 or in another section can be selected to ensure reliable interrogation of microfluidic channel contents such as particles. The location can be measured as a distance from the cover layer 131 in some embodiments. The location of the interrogation region 113 can correspond to a depth of focus of the illumination or detection systems that interface with the microfluidic chip 100. In some embodiments, a degree of isolation of individual microchannels and objects (e.g., particles) within the microchannels (e.g., spacing between microchannels) can be selected to ensure reliable interrogation of microfluidic channel contents such as particles. An appropriate location of the interrogation region 113 within a single microchannel can be selected to ensure that a target (e.g., single) particle of interest is suitably isolated and can be measured as being independent of other particles. In one embodiment, the location of the interrogation region 113 enables measurement of single particles. It may be desirable in some embodiments to measure multiple particles. In some embodiments, the location of the interrogation region 113 enables measurement of a single “event” where the event is characterized by receipt of optical signals from one particle or multiple particles within a specified time span or coincidence interval.

In some embodiments, the sections of the microfluidic chip 100 can be manufactured separately and combined or assembled to form the microfluidic chip 100. To create sections with very high feature density, a number of manufacturing or fabrication methods can be used to create each section such as lithography, additive manufacturing (e.g., three-dimensional printing), sputtering, deposition, molding, embossing, imprinting, subtractive manufacturing (e.g., machining, milling, chemical etching, ion-beam etching, electrical discharge machining), or other methods known to the ordinary skilled person to fabricate structures having materials, features, functionality, and dimensions that are suitable for the desired purposes. In some embodiments, different combinations of materials can be used to fabricate sections. Optically functional or biologically functional layers may also be provided through various fabrication processes. A substrate plus add-on material approach can be used such as conductive electrodes on a non-conductive material. The selection of materials and coatings may be made according to the specific application (such as for cell sorting), according to Good Manufacturing Practices (GMP), according to the desired method of sterilization or clean-in-place program (such as gamma irradiation, gases, vapors, or other cleaning and sterilization matters), or according to any combination of these. Individual layers or sections can be produced from one or more materials including silicones, glasses (e.g., UV fused silica, quartz, or borofloat), polymers (e.g., polydimethylsiloxane [PDMS], polymethyl methacrylate [PMMA], thermoplastic elastomers [TPE] including styrenic TPE, or cyclic olefin copolymer [COC]), metals, ceramics, alloys, or crystalline materials. Materials can be selected for particular properties such as electrical conductance or impedance or acoustic transmissivity. The materials or surfaces of one or more sections can be prepared or treated to be suitable for cell measurement or sorting so that the cells are not adversely affected as they travel through the system. In some embodiments, the materials or surfaces of the sections can be treated to enhance the cells in some way as they move through the assembly. In some embodiments, layers or sections that are closer to optical interrogation and detection systems (e.g., closer to a top surface of the chip) are made of materials that are transparent while layers or sections that are further from the optical interrogation and detection systems (e.g., closer to a bottom surface of the chip) are made of opaque materials, which may be less expensive or easier to fabricate, or reflective materials. In this way, the chip 100 maintains a high level of optical access where it matters (i.e., near the interrogation regions 113) while also benefiting from ease of manufacturing and lower cost for sections that do not necessarily require high optical access such as the transfer section 110. In some embodiments, high feature density can be achieved by having a small area of the microfluidic chip 100 occupied by each particle processing unit 101 as measured on a top surface of the microfluidic chip 100 or as measured on a top surface of the cover layer 131.

In some embodiments, the microfluidic chip 100 includes sections that can be configured to be disassembled (i.e., reversibly assembled) back into component parts (e.g., separate sections). In some embodiments, one or more bonding, adhesion, fusion, or contact processes can be used to permanently join sections to form a microfluidic chip 100 that cannot be disassembled. The microfluidic chip 100 can be cleanable, sterilizable, or reusable in whole or in part. For example, an example microfluidic chip 100 can be disassembled with certain sections (e.g., particle focusing section 120 or transfer section 110) being disposed of and replaced with new sections while other sections (e.g., actuator section 130 together with, or separated from, the cover layer 131) are configured to be sterilized and reused. Certain sections may be more likely to be reused due to specialized or expensive materials (e.g., glasses or plastics) or because additional components are integrated into the section (e.g., surface acoustic wave electrodes deposited on a layer in the actuator section 130).

In some embodiments, more than one section or all of the sections can be formed in a unitary process using, for example, a three-dimensional printing process.

The microfluidic chip 100 can include additional sections or layers beyond those illustrated in FIGS. 1-4B. For example, the microfluidic chip 100 can include layers or sections that passively allow material (e.g., fluids or particles) to flow through the layer or section unaltered or unaffected. These layers or sections can perform a “via-like” function (akin to vias in multi-layer printed circuit boards including hollow bores or apertures extending therethrough) to facilitate access to or connection of the plumbing/fluidic connections, electrical contacts, optical conduits, mechanical actuation elements, or other aspects of the chip. In some embodiments, certain layers can be shared among stacked or layered sections of the microfluidic chip 100 to create shared commonalities such as shared functionality, shared materials, shared electrical connections, shared optical conduits or connections, shared thermal properties, and more to facilitate particle flow, focusing, detection, or sorting operations.

Any of the transfer section 110, the particle focusing section 120, or the actuation section 130 can include one or more material layers. The layer can include suitable materials, coatings, or chemical treatments to achieve the desired functionality for flowing particles and fluids, enabling measurements such as optical or electrical measurements, manipulating fluids or particles, further processing of fluids through manifolding, collecting, transporting, or controlling fluids so that a desired process can be performed. The vertical stacking of layers and sections can be designed or fabricated so that optical, mechanical, electrical, or other signals can be transmitted through the layer as needed in a controlled manner. The materials used for a given layer can be optically transparent or opaque, spectrally selective, or polarization sensitive as needed. The materials can have a specified refractive index or light absorption, reflection, or refraction characteristics. Certain layers (such as the cover layer 131) can include means to generate or detect light. Layers of the massively parallel microfluidic chip 100 can be electrically conductive, electrically insulating, or semiconducting in different embodiments. Layers of the massively parallel microfluidic chip 100 can have material attributes or embedded or attached mechanical elements that enable transmission, dampening, or blocking of energy such as acoustic energy.

FIG. 2 illustrates a ‘left-right’ particle sorting scheme where the output flow paths 106, 108 are shown in this cross-sectional view as parallel and separated by 180 degrees in the plane of the chip 100 (i.e., as viewed from above). However, it should be understood that the orientation of the output paths 106, 108 is not limited to the 180 degree layout shown in FIG. 2, but that the output paths could branch away from the microfluidic channel 114 in any direction.

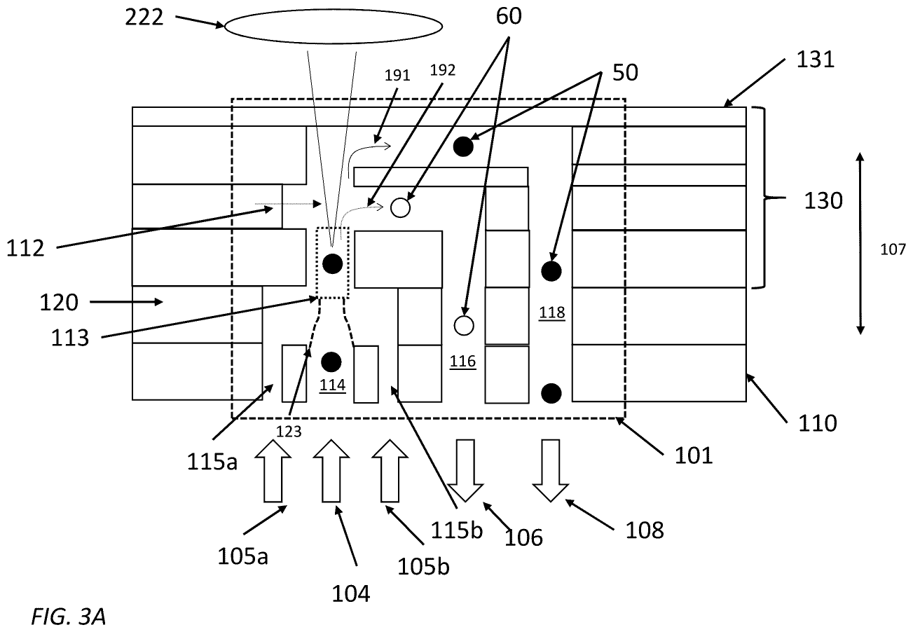

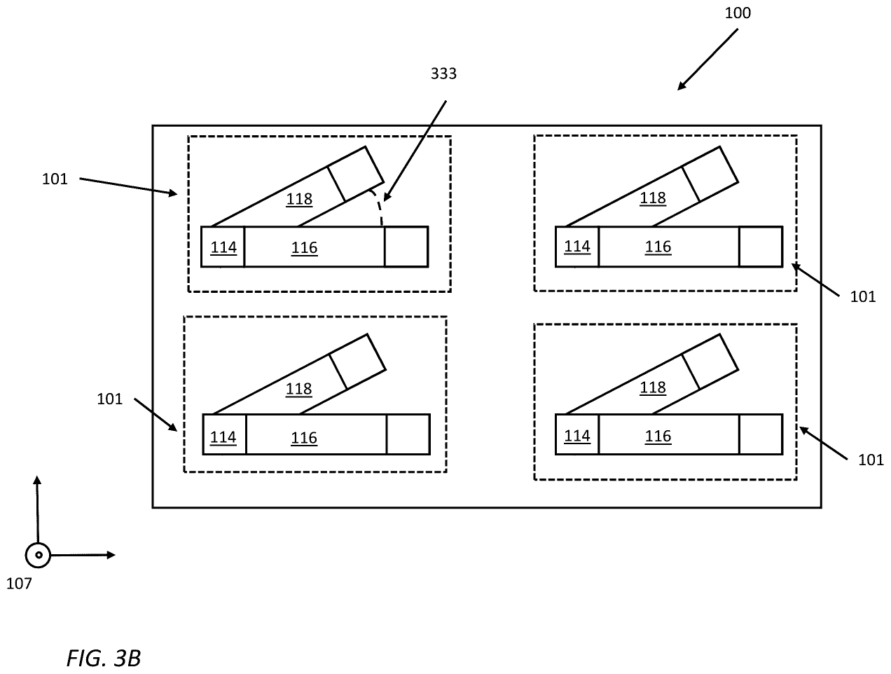

FIG. 3A illustrates one embodiment of the microfluidic chip 100 which can be described as a ‘right-right’ particle sorting scheme. In this embodiment, sample fluid including particles 50, 60 flow upwards through the transfer section 110 on first flow path 104 into the main microchannel 114 while sheath fluid flows through the transfer section 110 on sheath fluid flow input paths 105a, 105b into respective sheath channels 115a, 115b. The sample fluid including particles contacts sheath fluid and is focused by the sheath fluid in the particle focusing region 123 of the particle focusing section 120. The particles flow to the interrogation region 113 where they can be detected using a detection system such as an optical detection system using a lens 222. Based upon the detected signal (e.g., an optical fluorescence, scattering, emission, or extinction) from the particle in the interrogation region 113, a control system such as a computing device can identify whether the particle is a desired particle 60 or an undesired particle 50. When a desired particle 60 is detected, the actuator 112 is actuated to divert the particle to a first output path 106. When an undesired particle 50 is detected, the actuator 112 can take no action such that the undesired particle 50 passes on a natural flow path to the second output channel 108. In this embodiment, both output microchannels 116, 118 are situated to the same direction with respect to the microfluidic channel 114 but are “stacked” one atop the other in the stacking direction 107. In other words, one output channel can pass or cross above or underneath the other output (or input) channels along the stacking direction (i.e., a line drawn through the chip in the stacking direction can pass through two or more microchannels).

In the embodiment of the chip shown in FIG. 3A, the output channels pass directly below one another with a zero-degree relative angle between the output channels as viewed from above the chip (i.e., a zero-degree rotation around the stacking direction 107). However, it should be understood that the output channels 116, 118 can branch away from the microfluidic channel 114 with some relative angle between the channels in a range from zero to 360 degrees. An example of a similar “right-right” microfluidic chip 100 including angled branch channels is illustrated by the top view of FIG. 3B. In this example, four particle processing units 101 are shown as seen looking down through the cover layer 131. In other words, the main microchannel 114 is flowing “out of the page” at the viewer along the stacking direction 107. The second output microchannel 118 branches away from the main microchannel 114 at an angle 333 with respect to the direction at which the first output microchannel 116 branches away from the main microchannel 114. Moreover, the orientation of particle processing units 101 on a same chip can be rotated with respect to the orientation of other particle processing units 101. Such relative rotation can improve packing densities in some embodiments by simplifying manifolding paths by locating common microfluidic channels more proximately, e.g., by locating the sample input paths 104 or output channels 116, 118 of several particle processing units 100 nearer to one another.

In some embodiments, the placement of channels in the microfluidic chip enables sort monitoring wherein particles 50, 60 can be measured downstream of the actuator 112. Sort monitoring is a process that provides confirmation of the success or failure of a particular sorting or actuation operation. Once a sort decision has been undertaken and an actuation has occurred, sort monitoring devices (for example, as part of a detection system) can measure the actual path of a particle relative to the expected or desired path. In FIG. 2, the lens 224 provides sort monitoring for particles in the first output channel 116 while the lens 226 provides sort monitoring for particles in the second output channel 118.

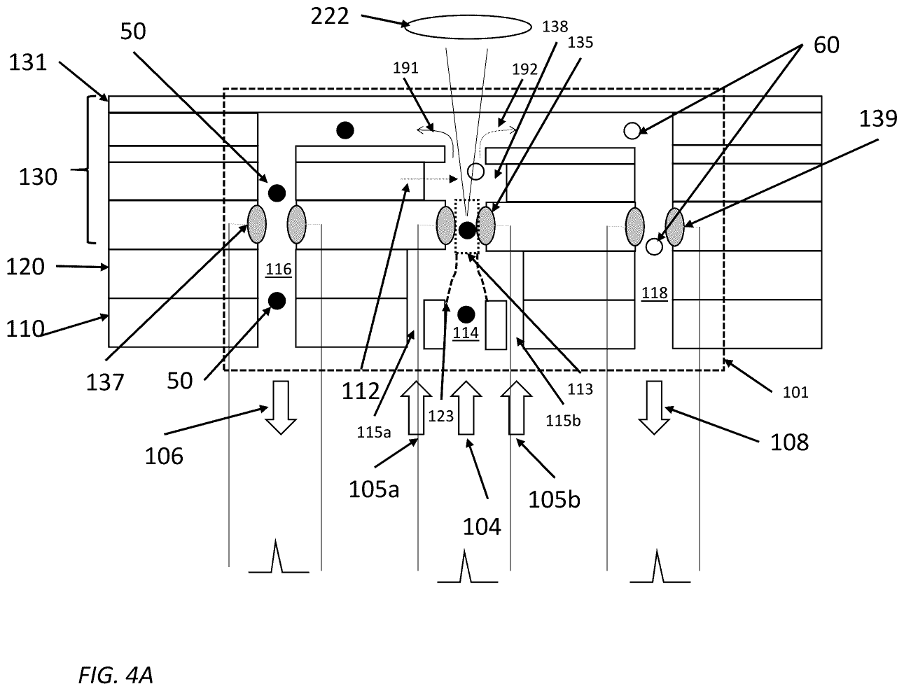

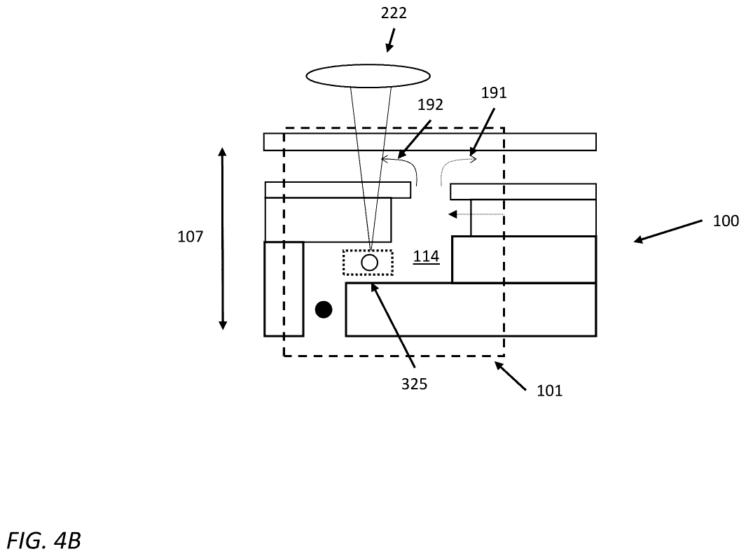

FIG. 4A illustrates an embodiment of the microfluidic chip 100 and provides a different mechanism for sort monitoring. In FIG. 4A, the microfluidic chip 100 includes an input electrical sensor 135 associated with the microfluidic channel 114 and output electrical sensors 137, 139 associated with respective output channels 116, 118. The input electrical sensor 135 can detect the presence of a particle 50, 60 in the microfluidic channel 114. The output electrical sensors 137, 139 can detect the presence of particles in their respective output channels. The electrical sensors 135, 137, 139 can operate to detect the presence of a particle using the Coulter principle, measured conductivity (or interruptions/disruptions of the conductivity), electrical resistivity, or other methods. The electrical sensors 135, 137, 139 can be formed to use conductive traces placed throughout the chip stack to afford massively parallel particle measurement. The conductive traces can feed out of the microfluidic chip 100 at one or more edges of the chip and thereby connect to the control system.

Signals from the electrical sensors 135, 137, 139 can be received by a control system. The control system can compare the detected location of a particle in the output channels (based upon signals from the output electrical sensors 137, 139) to the expected location of the particle based upon an earlier sort decision and actuation. This information can provide valuable feedback to the control system as to sorting success rate and can become the basis for real-time or delayed adjustments to sorting or detection parameters to improve sorting success rate. The control system can receive signals from the input electrical sensor 135 that can identify particle characteristics upon which a sort decision can be based. This information can be obtained by the electrical sensor 135 instead of using optical measurement techniques or can be obtained in addition to using optical measurement techniques. In some embodiments, signals from the input electrical sensor 135 can be used as a verification system to measure success in measurement using a different detection system (e.g., an optical detection system).

In some embodiments, the input electrical sensor 135 is co-located with the interrogation region 113 such that the particle is detected nearly simultaneously with the input electrical sensor 135 and any other detection system such as an optical detection system. In other embodiments, the input electrical sensor 135 can be located at a different position on the flow path from the interrogation region 113. In the figure, the electrical sensors 135, 137, 139 are depicted as being present in the actuation section 130. However, the electrical sensors can be located in different layers within a same section or in different sections of the microfluidic chip 100 in other embodiments.

FIG. 4B illustrates an embodiment of a microfluidic chip 100 including a particle processing unit 101 that features a horizontal segment 325 of the microchannel that runs parallel to the cover layer 131. The interrogation region 113 can be located at the horizontal segment 325 where all or a majority of fluid flows horizontally (i.e., transverse to the stacking direction) in such embodiments so that the optical interrogation and detection are performed as the particles move perpendicularly to the stacking direction 107 and perpendicularly to the optical axis of any illumination system or detection system that is probing the particles. Use of the horizontal segment 325 may be advantageous in some embodiments by making particle measurements more uniform as the particles flow transverse to the optical axis of the optical detection and illumination systems rather than along the optical axis. Note that the fluidic travel of the particles throughout the chip is still predominantly along the stacking direction 107 even though the interrogation region 113 is located in a portion of the microfluidic channel 114 that travels laterally with respect to the stacking direction 107. Because the flow is still predominantly along the stacking direction 107, the microfluidic chip still takes advantage of massive parallelization by enabling large numbers of particle processing units 101 to be fit on a single chip.

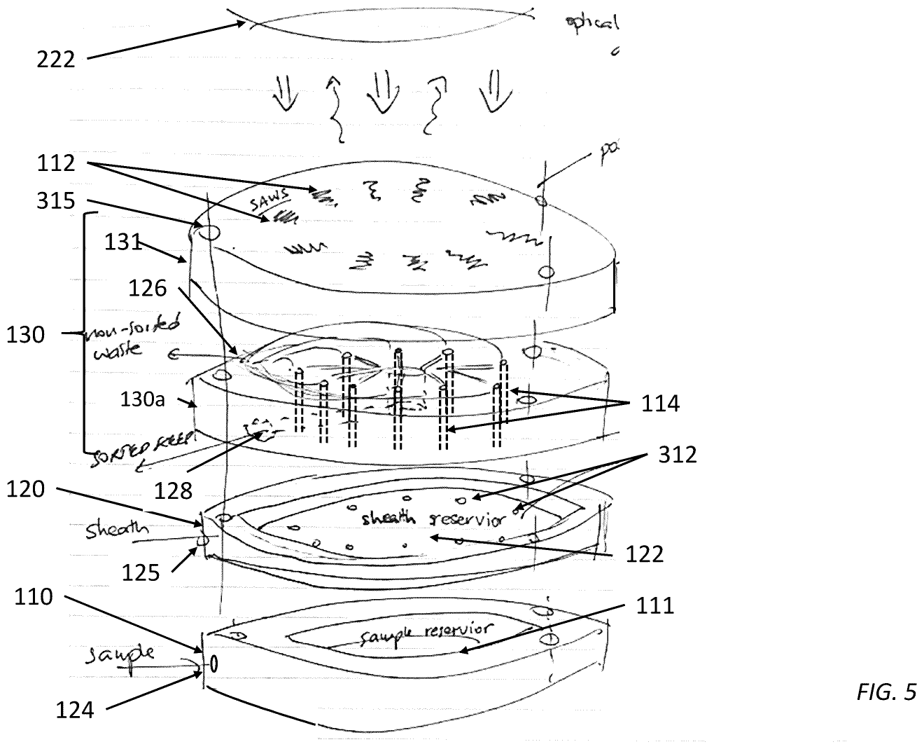

FIGS. 5 and 6 illustrate an embodiment of the microfluidic chip 100 where the actuators 112 are located in or on the cover layer 131 of the actuation section 130 in accordance with various embodiments taught herein. For example, the actuators 112 can include IDTs or other structural features that produce acoustic energy. As shown in the partial cross-sectional view of FIG. 6, the actuator 112 in contact with the cover layer 131 can couple acoustic energy into the vicinity of the junction between the input microchannel 114 and the output channels 116, 118. The actuator 112 can selectively divert or direct the particles 50, 60 to the proper output channels 116, 118 by applying acoustic energy to the particles 50, 60.

Returning to FIG. 5, in some embodiments the microfluidic chip 100 is formed from a circular substrate. In various embodiments, the microfluidic chip 100 can have a rectangular or square form factor (such as in FIG. 1), a circular or ovular form factor (as in FIG. 5), or any other appropriate form factor to meet application-specific considerations. The transfer section 110 includes a sample inlet 124 to input sample fluid including particles. In some embodiments, the sample fluid is collected in an on-chip sample fluid reservoir 111 from where the sample fluid can enter each of the multiple microchannels 114. Similarly, the particle focusing section 120 can include a sheath fluid inlet 125 that enables input of sheath fluid into the microfluidic chip 100. In some embodiments, the sheath fluid enters an on-chip sheath fluid reservoir 122 from where the sheath fluid can be introduced into the multiple microchannels 114 to focus particles in the sample fluid stream. In some embodiments, the sheath fluid inlet 125 is coupled to a manifold that distributes the sheath fluid to focusing section 120 of each of the particle processing units 101. The focusing section 120 can include a plurality of nozzles 312 to facilitate introduction of sheath fluid to the sample fluid stream in the microchannels 114. In some embodiments, the nozzles can produce a jet-like flow of sample fluid into a surrounding volume of sheath fluid.

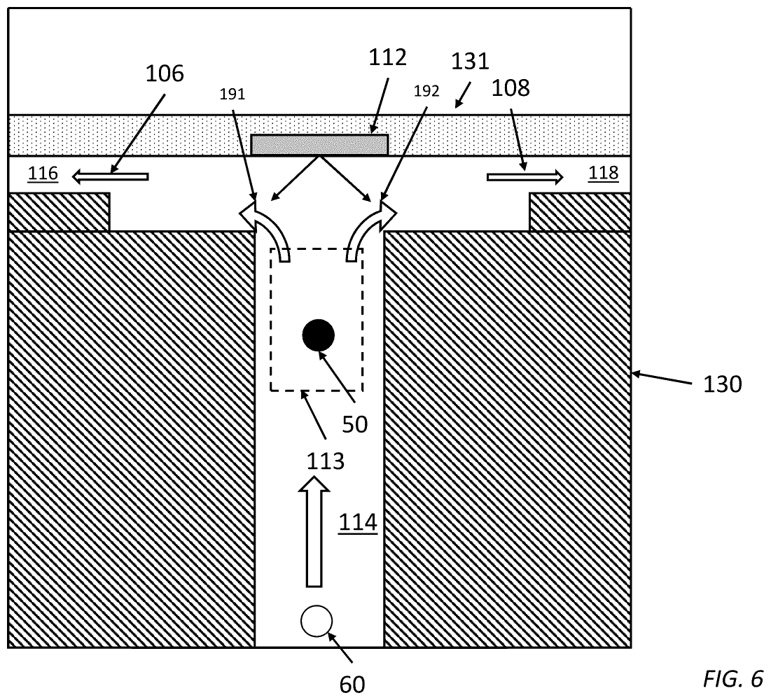

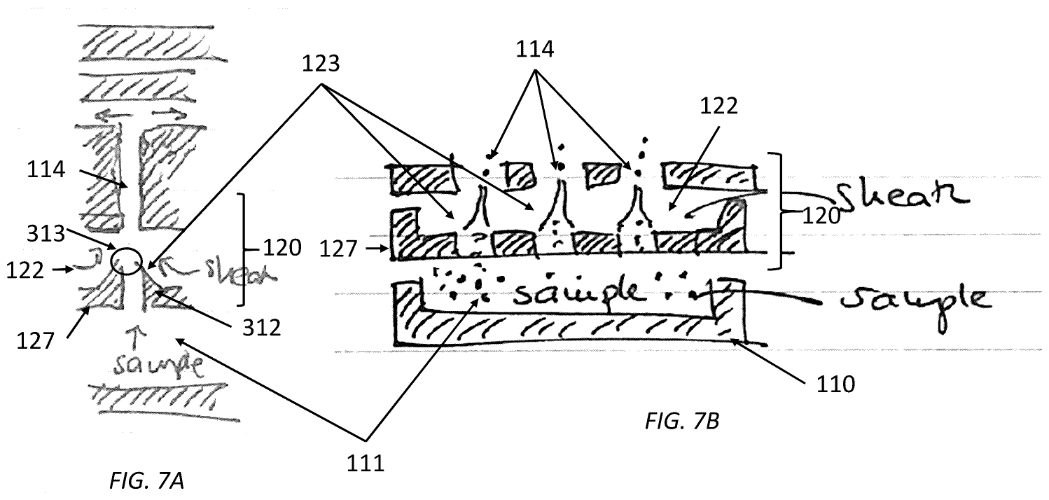

FIGS. 7A and 7B illustrate magnified views of embodiments of the transfer section 110 and the particle focusing section 120 including a plurality of particle focusing regions 123. As seen in FIG. 7A, the particle focusing region 123 can be integral with a layer within the particle focusing section 120. In some embodiments, the particle focusing region 123 can include nozzle-like features 312 formed by protrusions 313. In some embodiments, the particle focusing region 123 can include orientation features that induce changes in orientation in particles (e.g., asymmetric particles like sperm cells can be oriented in a preferred direction). As shown in FIG. 7A, sample fluid flows upward from the on-chip sample reservoir 111 through the interior of a layer 127 of the particle focusing section 120 forming the nozzle 312 and is expelled through the nozzle 312 into sheath fluid in the on-chip sheath fluid reservoir 122. In some embodiments, the sample fluid flows upward from a manifold (not shown) through the interior of the layer 127 of the particle focusing section 120 forming the nozzle 312 and is expelled through the nozzle 312 into sheath fluid. The sheath fluid is under pressure to flow into the microchannels 114 and thus acts on the sample fluid to focus particles in the stream within the microfluidic channel 114. FIG. 7B illustrates a cross-sectional view of a microfluidic chip 110 wherein the particle focusing regions 123 feed sample into multiple parallel microchannels 114. In this figure, streamlines are illustrated for each sample stream as it is narrowed and focused by action of the pressurized sheath fluid. Each sample stream in each microchannel 114 is focused by the sheath fluid in the on-chip sheath fluid reservoir 122.

In some embodiments taught herein, the output channels 116, 118 flow back downward through the chip and exit the chip in or through the transfer section 110. However, in some embodiments such as the chip 100 of FIG. 5, the actuation region 130 can include a keep outlet 128 connected to the first (or keep) output channel 118 and a waste outlet 126 connected to the second (or waste) output channel. The outlets 126, 128 can pass through a sidewall 130a of the actuation section 130 in some embodiments. The sidewall 130a can be an outer wall or circumference of the chip 100 that is perpendicular to a top surface (e.g., an outside surface of the cover layer 131) through which optical interrogation and detection occur.

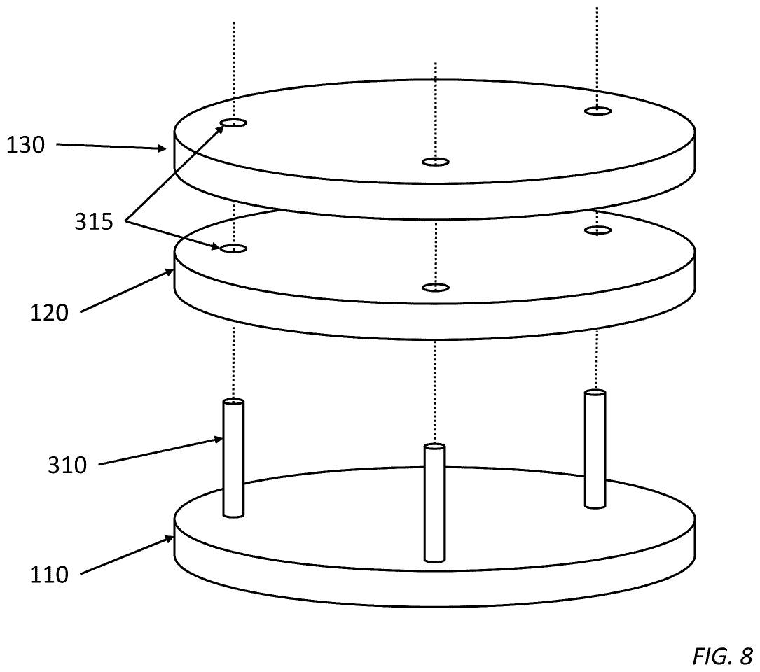

Sections of the microfluidic chip 100 can be prepared or manufactured separately. In some embodiments, each section (e.g., transfer section 110, particle focusing section 120, and actuation section 130) can include one or more alignment holes 315. As shown in FIG. 8, the alignment holes enable the separate sections 110, 120, 130 to be aligned and assembled into the final microfluidic chip 100. For example, alignment posts 310 can be inserted through the alignment holes 315 in one or more of the sections. Although the posts 310 are illustrated as passing through all of the sections, the posts 310 can be permanently affixed to, or manufactured as part of, one or more of the sections. In this situation, the remaining sections can be positioned with alignment holes 315 aligned with the posts 310 and slid onto the posts to join sections to form the chip 100. In some embodiments, the posts 310 may be removable from sections of the microfluidic chip 100 before assembly of the final microfluidic chip 100. For example, the posts 310 may be removed after insertion through the alignment holes 315. The posts 310 may, for example, break off the underlying sections during assembly of the microchip 100 after the sections are joined.

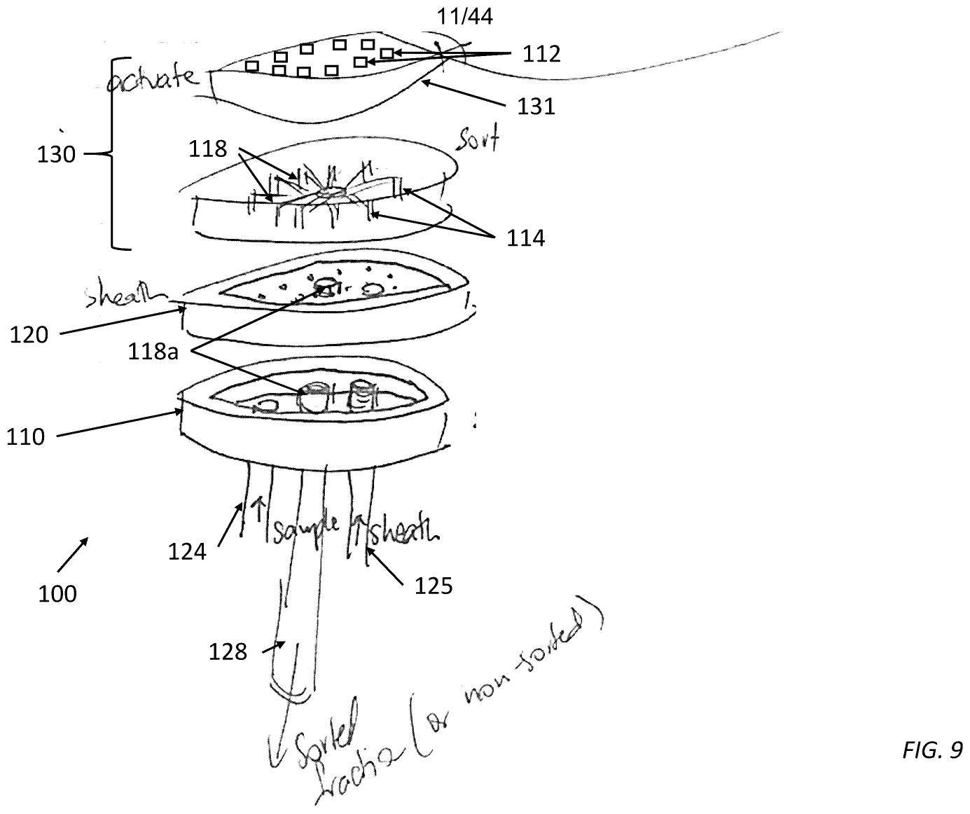

FIG. 9 illustrate an embodiment of the microfluidic chip 100 that includes a central output channel 118 that is connected to output channels from each individual particle processing unit 101 of the microfluidic chip. In some embodiments, the interrogation regions and actuators are positioned at different azimuthal locations surrounding a center of the chip 100. The actuators 112 divert desired particles into output channels 118 that feed towards the center of the chip 100. At the center of the chip 100, the output channels 118 combine into a single output channel 118a that flows downward through the actuation section 130, the particle focusing section 120, and the transfer section 110. The sorted particles in the output channel 118 then exit the chip through the keep outlet 128. In some embodiments, the keep outlet 128, sample inlet 124, and sheath inlet 125 are illustrated as passing through a bottom surface of the microfluidic chip. In other embodiments, one or more of these inlets and outlets can be positioned on a sidewall or a top surface (i.e., through the cover layer 131) of the chip 100.

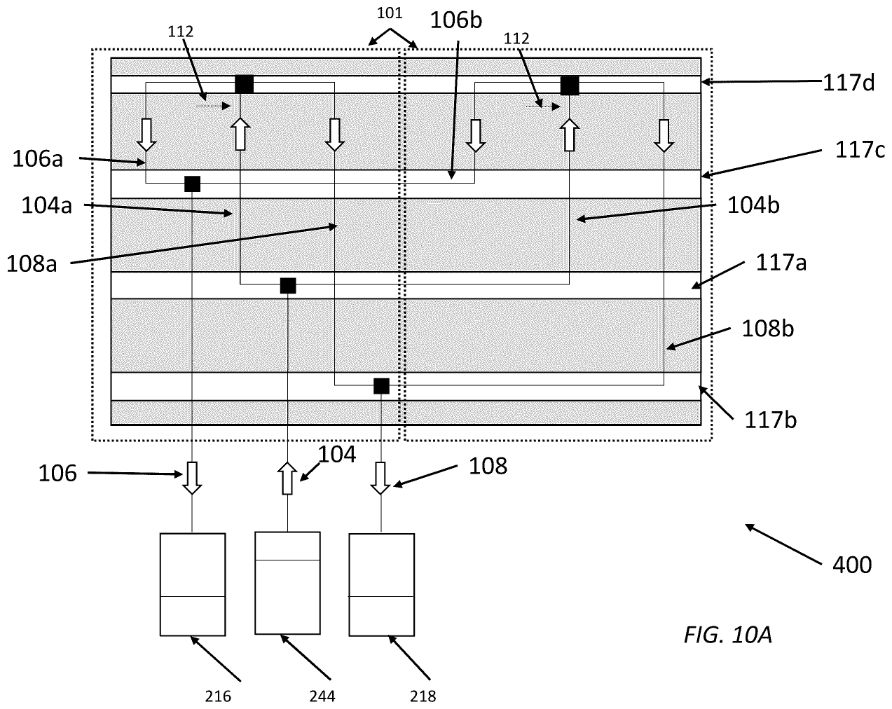

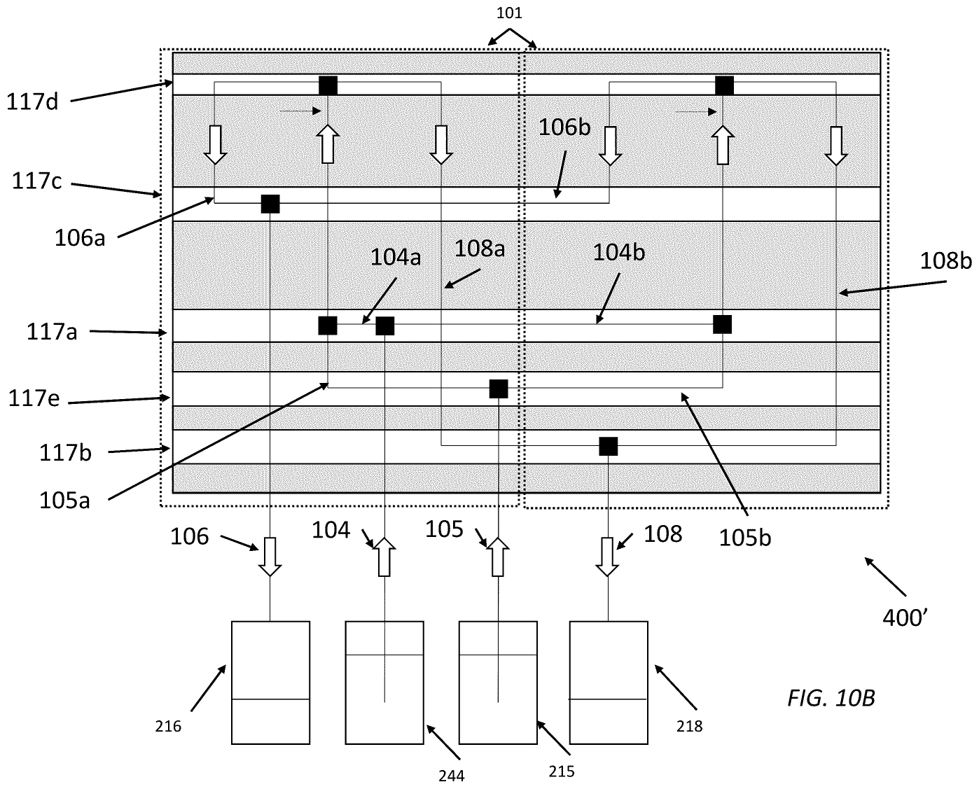

FIGS. 10A and 10B schematically illustrate various fluidic manifolding or plumbing embodiments that are suitable for the microfluidic chips 100 taught herein. The fluidic manifolding can extend through one or more of each of the sections described above to provide fluid coupling to each of the sections. The fluidic manifold 400, 400′ can include a microfluidic channel assembly configured to receive particles via one or more input fluid communication elements from a particle source supply (i.e., an off-chip sample fluid reservoir 244) and to send particles to a collection system (including, for example, off-chip collection reservoirs 216, 218) via one or more output fluid communication elements. FIG. 10A illustrates a possible layering of chip substrates that may be used to enable manifolding between layers to achieve the desired fluid flow (and transport of particles) throughout the system. In FIGS. 10A and 10B, the black boxes indicate a position where fluid from a single pathway divides into multiple pathways or where fluids from multiple pathways combine into a single pathway (i.e., a fluidic junction). Fluid pathways that cross in this schematic drawing but without a black box at the crossing do not intersect to form a fluidic junction in the actual chip. The microfluidic chip 100 is plumbed in such a manner that each of the plurality of particle processing units 101 receives particle-laden sample fluid from a sample fluid reservoir 244 (either on-chip or separate from the chip) along an input fluid path 104 via an appropriately manifolded means to the interrogation region 113 where said particles 50, 60 are interrogated and characterized. In some embodiments, the particles 50, 60 may be diverted on an individual basis to one of multiple outlet paths 106, 108 via a suitable sorting mechanism such as the actuator 112.

The fluidic manifold 400 can include distribution layers 117a-e that facilitate dividing or combining of fluidic pathways. For example, the distribution layer 117a can split the input fluid path 104 from the reservoir 244 into a number of input fluid paths 104a, 104b that travel within the distribution layer 117 to individual particle processing units 101. Likewise, the distribution layer 117b can combine fluid coming from the output paths 108a, 108b from different particle processing units 101 into a single output path 108 that flows to the collection reservoir 218. The distribution layer 117c combines fluid coming from the output paths 106a, 106b of different particle processing units 101 into a single output path 106 that flows to the collection reservoir 216. The distribution layer 117d splits fluid after it passes the actuator 112 into the first output path 106a, 106b and the second output path 108a, 108b. Distribution layers 117a-e can be formed within any individual section including the transfer section 110, the particle focusing section 120, or the actuation section 130. The distribution layers 117a-e can also span across sections or provide the bridge between different sections. In some embodiments, diverted (and non-diverted) fluids from each microfluidic cytometer element can be pooled using a manifold within the chip stack and collected within a suitable container (or connected to another process).

FIG. 10B shows a fluidic manifold 400′ that also uses sheath fluid from a sheath fluid reservoir 215 as a means to aid the transportation of sample, to offer hydrodynamic focusing, to reduce contact between particles and internal channel walls, to singulate, entrain, or otherwise distribute particles reliably for the purposes of transport, measurement, sorting, concentration/dilution or the like including a combination of more than one of these functions. Further, sheath fluid may be used to support or modify the biochemical status of sample. The addition of the sheath fluid path 105 to the chip 100 in FIG. 10B is facilitated by a distribution layer 117e that divides the sheath fluid path 105 into separate sheath streams 105a, 105b that flow to each individual particle processing unit 101 in the chip 100. The distribution layer 117a in FIG. 10B also functions as the location where sheath and sample fluids meet and effects such as hydrodynamic focusing can occur. Note that the distribution layers 117a-e can include a single physical layer or patterned substrate or can include a stack of multiple layers or substrates. In particular, distribution layer 117a in FIG. 10B can include several stacked or layered substrate layers to enable contouring of the microfluidic channel 114 formed therein to provide focusing or to direct fluid as needed.

FIGS. 10A and 10B illustrate embodiments with a single sample fluid reservoir 244 and a single sheath fluid reservoir 215. However, it should be understood that the microfluidic chip 100 can interface with multiple fluid reservoirs 244, 215 in some embodiments. For example, the microfluidic chip 100 can include sub-manifolds that each are associated with their own sample fluid reservoir 244 and sheath fluid reservoir 215. In some embodiments, the microfluidic chip 100 can engage with a fluid cartridge that includes the sample fluid reservoir(s) 244 and sheath fluid reservoir(s) 215. The combined chip and cartridge can be enclosed and sealed (or be selectively sealable) from an external environment and can be configured for removable engagement with a particle processing system 200 as described below. In some embodiments, the fluidic system (i.e., fluidic microchannels and manifolding elements for fluid transport) can be provided as a sealable cartridge or chip that can operatively enclose all of the fluid contact surfaces used during particle processing (i.e., the sealable cartridge or sealable chip can be operatively sealed during any particle processing operation such that fluid does not enter or leave the chip during the particle processing operation). The cartridge can also include the output reservoirs 216, 218 on board.

In some embodiments, the microfluidic chip can be disposable. This may provide a benefit in combination with sealable fluid contact surfaces in that the operator can avoid contact with fluids in the chip (to improve biosafety) and the fluid avoids contamination by outside factors during processing. The sample can be withdrawn from a sorted sample chamber on the chip after processing and the chip can be discarded to avoid cross-contamination of samples or sheath from different experimental runs. In other embodiments, the microfluidic chip 100 can be formed of materials that can be sterilized such that the microfluidic chip 100 can be reused. For example, the materials can be selected to withstand sterilization treatments including one or more of ethylene oxide, ultraviolet light, or high heat and pressure. The microfluidic chip 100 can be removable and engageable with a particle processing system as described below.

A microfluidic particle analysis and/or sorting system 200 that includes or that can be operatively coupled to the massively parallel microfluidic chip 100 in accordance with embodiments of the present disclosure can have a wide variety of applications as a cell sorting platform for gender preselection in mammals by sorting sperm by sex, as a therapeutic medical device enabling cell-based therapies, in clinical diagnostics to aid in the monitoring of disease in humans or other animals, or in one or more drug development applications.

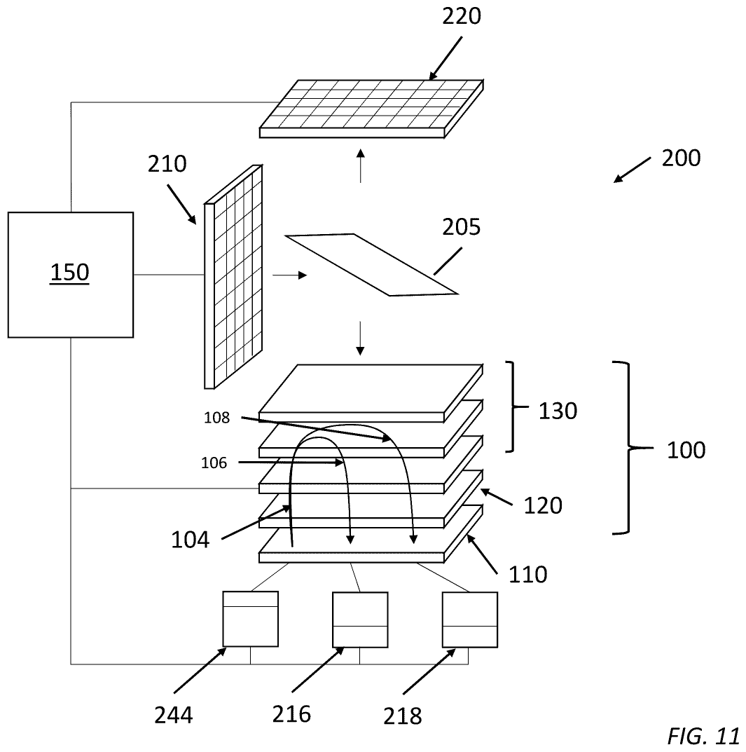

In FIG. 11, an ultra-high throughput particle processing system 200 suitable for implementing an illustrative embodiment of the present disclosure is schematically illustrated. The particle processing system 200 includes the microfluidic chip 100, an electromagnetic source system 210, a detection system 220, a light separation system 205, and a computing device 150. One or more sample reservoirs 244 can supply sample fluid including particles to the transfer section 110 where the sample fluid is divided into multiple fluid input paths 104 that each correspond to a particle processing unit. Along each fluid input path 104, particles in the fluid are focused in the particle focusing section 120 and arrive at an interrogation region. In some embodiments, the interrogation region is in the actuation section 130. The electromagnetic source system 210 is configured to illuminate the interrogation regions in each of the multiple microchannels. The detection system 220 is configured to receive light that has been emitted or scattered from particles in the interrogation region that is indicative of a characteristic or identity of the particle. The detection system 220 receives and processes light simultaneously from each of the plurality of particle processing units in the chip 100. The light separation system 205 can include one or more spectrally selective elements such as dichroic beam splitters or reflectors and can enable portions of the illumination light path from the electromagnetic source system 210 to overlap with the detection light path of the detection system 220. In some embodiments, the light separation system 205 can include a low-pass filter with a cut-off frequency at 480 nm. The computing device 150 receives signals from the detection system 220 and controls operation of actuators in the actuation section 130 to selectively direct particles into the first fluid output path 106 or the second fluid output path 108. Particles in the first fluid output path 106 flow into a first output reservoir 216 (sometimes referred to as a “keep” reservoir) while particles in the second fluid output path 108 flow into a second output reservoir 218 (sometimes referred to as a “waste” reservoir).

The computing device 150 can monitor, measure, calculate, characterize, and make necessary steps to command and control certain components within the system to alter their state, and or alter the path of one or more particles. The computing device 150 can include a computer with a processing unit or can include another electronic device and can communicate with one or more other similar or different processors to perform the necessary function required. In some embodiments, the computing device 150 can utilize one or more sensors to be able to reliably, predictably, accurately, and reproducibly take an action. The computing device 150 may be partly or wholly integrated into a microfluidic chip substrate stack in various embodiments.

The particle processing system 200 may be configured, dimensioned or adapted for analyzing, sorting and/or processing (e.g., purifying, measuring, isolating, detecting, monitoring and/or enriching) particles (e.g., cells, microscopic particles, nanoparticles, molecules, etc.). For example, the system 200 can be a cytometer, a cell purification system, or the like, although the present disclosure is not limited thereto. Rather, the system 200 may take a variety of forms, and it is noted that the systems and methods described may be applied to other particle processing systems.

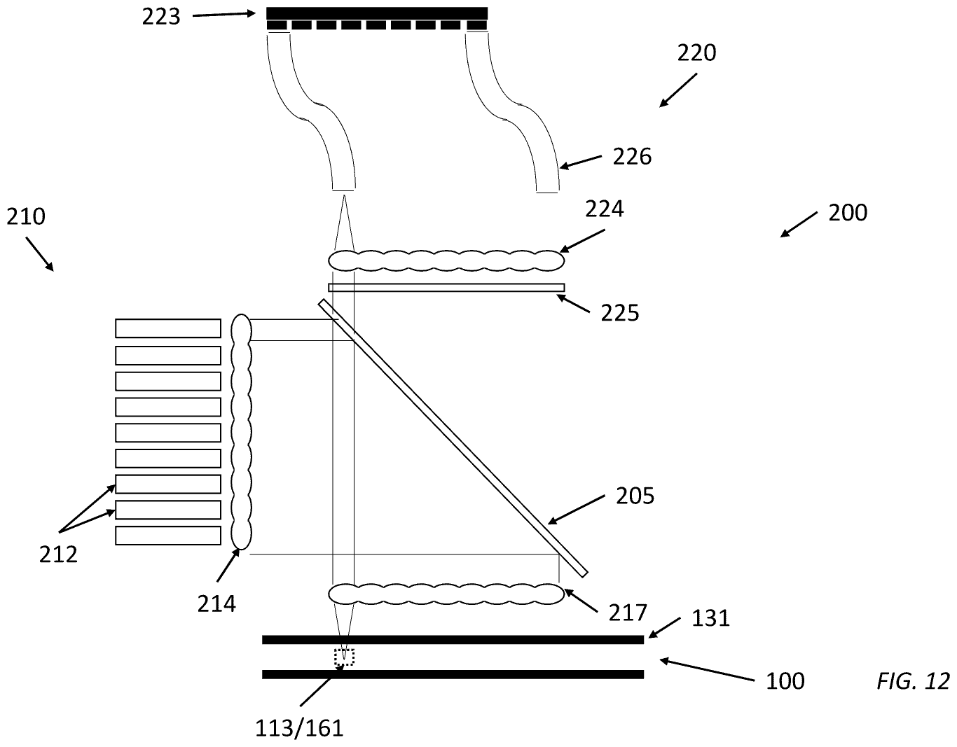

FIG. 12 illustrates a side schematic view of the particle processing system 200 with particular focus on the electromagnetic source system 210, the detection system 220, and the light separation system 205. The electromagnetic source system 210 is used for precision illumination of particles within the multiple channels of the massively parallel microfluidic chip 100. The electromagnetic source system 210 can include one or more light sources 212 and one or more beam-shaping optics 214, 217. For example, the light source 212 can be a single source that outputs light over a large aperture or multiple discrete sources that output light individually. Likewise, the beam-shaping optics 214, 217 can include single monolithic optical elements such as a fixed array of microlenses or single macro lenses (e.g., microscope objectives) or can include multiple discrete optics such as separate microlenses that can be individually positioned transverse to the optical axis or multiple optics that are placed serially along an optical axis. The light source 212 is focused onto multiple locations within the microfluidic chip including each of the multiple interrogation regions 113 and, in embodiments that employ sort monitoring, the multiple sort monitoring regions 161/162.

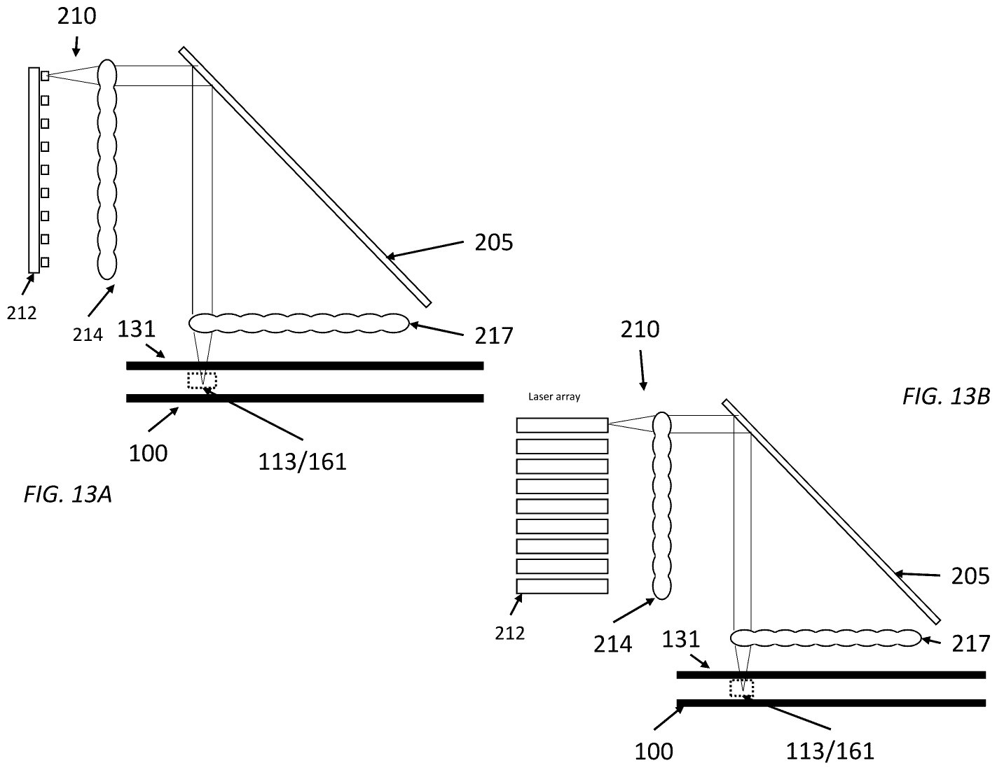

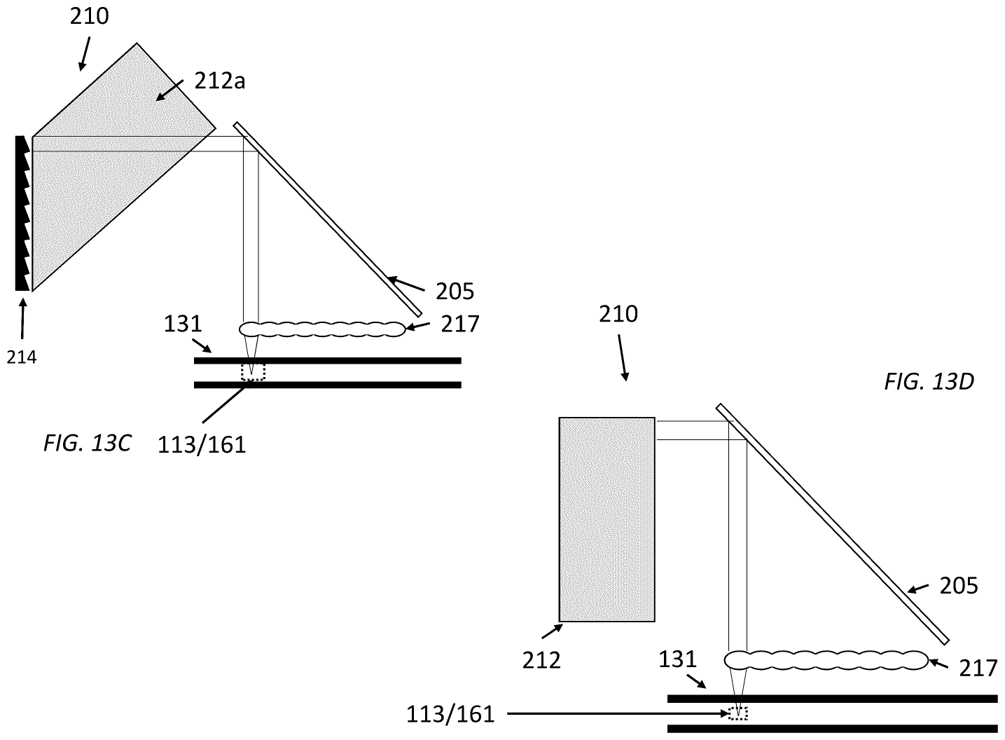

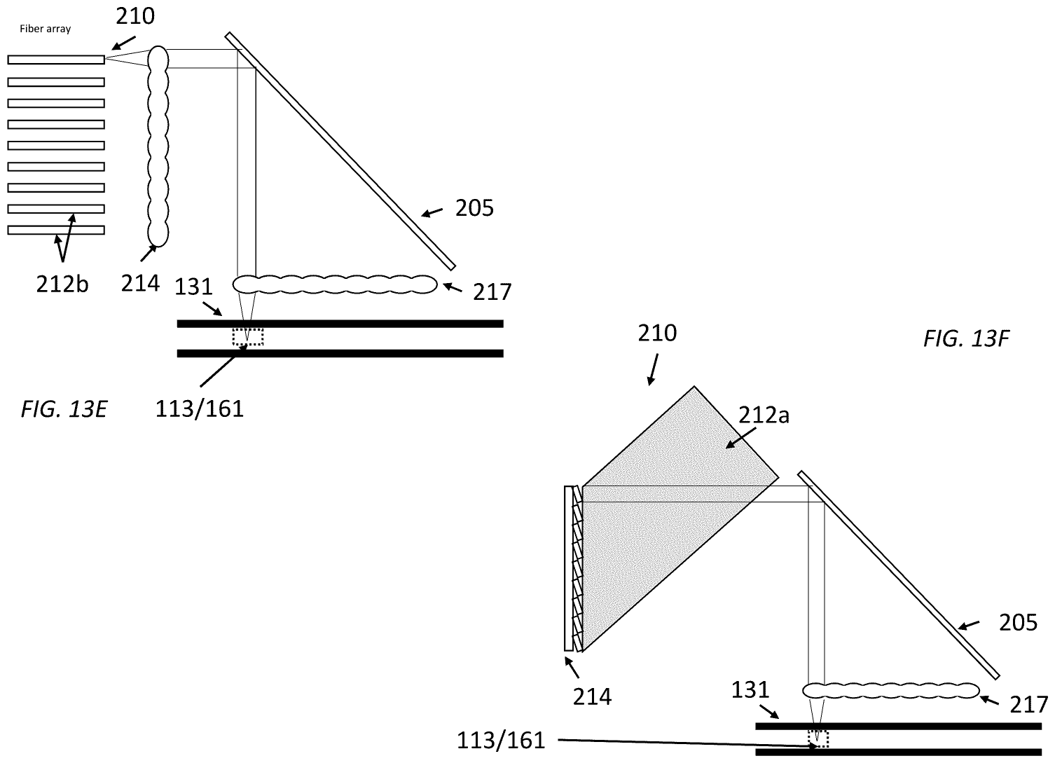

In some embodiments, particles in the microchannels 114 are reliably illuminated in an epi-illumination manner. The illumination light interacts with the particles to produce an optical signal based on one or more of fluorescence, reflection, scattering, or extinction that can be measured by the detection system 220. As described in greater detail below in FIGS. 13A-13F, the electromagnetic source system 210 can provide an illumination beam or multiple illumination light beams that can be flood-lit (i.e., a broad beam of relatively uniform intensity), split (e.g., through multiple elements such as multiple beam splitters), scanned/moved, multi-sourced (e.g., multiple laser sources such as one or more vertical-cavity surface emitting lasers (VCSEL) where multiple sources may be split), switched on or off as required, modulated periodically or otherwise (e.g., randomly) or any combination of the above. Excitation sources of different wavelengths may be used as needed for the specific application where certain attributes of particles of interest can be interrogated and measured. Excitation of the particles in the microfluidic chip 100 may occur using one or more transmissive or reflective optical elements such as one or more lenses, mirrors, optical fibers, tapered optical elements, diffractive elements, spectral elements, plasmonic elements, tapered optical elements, in any combination. The beam-shaping optics 217 can include a large-format lens (such as lenses described in U.S. Pat. No. 10,215,995, issued Feb. 26, 2019 and incorporated by reference herein in its entirety), a microscope objective (such as from Mitutoyo Corporation), or a multi-lens array (such as the microlens arrays and systems described in U.S. Pat. No. 10,190,960, issued Jan. 29, 2019 and incorporated herein by reference in its entirety). The beam-shaping optics 217 can focus light onto interrogation regions 113 or sort monitoring regions 161/162 of the microfluidic chip 100 and can receive light coming from the device such that an appropriate field of view is achieved to meet the needs of multiple microfluidic measurement sites within the device. Additional beam-shaping optics 217 (not shown) can include optical apertures, pinholes, stencils, or masks that enable only specific portions of the top surface of the cover layer 131 to be observed optically. The optical apertures can provide spatial filtering in some embodiments. The optical apertures can be fabricated on-chip or formed as a separate layer that is attached to or mated with the chip 100. In some embodiments, the optical apertures can be provided in a separate imaging plane. In some embodiments, the beam-shaping optics 214, 217 can include one or more lenses (including microlenses), mirrors, or filters including optical elements that can segment or split a beam into beamlets.

The detection system 220 includes one or more detectors 223 and one or more of the beam-shaping optics 217, 225, 224, 226. The detection system 220 collects light reflected, scattered, fluoresced, or extinguished (i.e., a light signal reduced by the presence of the particle) from the particle and projects the light signal through appropriate optical elements (including spectral selection, spatial selection, or both spectral and spatial selection elements) to sensors in the detector 223. Note that some optical elements such as the beam-shaping optic 217 in FIG. 12 can be a common element to both the electromagnetic source system 210 and the detection system 220 in some embodiments.

The light separation system 205 can include one or more spectral selection elements. For example, the spectral selection element can include a dichroic mirror that transmits or reflects light dependent upon the wavelength of the light.

FIG. 12 illustrates components of the electromagnetic source system 210 and the detection system 220 as discrete components separate from the microfluidic chip 100. However, in some embodiments certain components of these subsystems can be integrated directly into the stacked or layered configuration of the microfluidic chip 100. For example, the beam-shaping optic 217 can be formed directly on a top surface of the cover layer 131 in some embodiments.

In the embodiment illustrated in FIG. 12, the light source 212 includes a laser or broadband light source and the optical element is a microlens array 214. The beam from the laser or broadband source fills the collective aperture of a whole microlens array, and the microlens array divides the beam into beamlets. The beamlets are reflected from a spectrally selective reflector of the light separator system 205 and are directed to a second microlens array 217. The second microlens array 217 focuses the illumination light onto the interrogation regions 113 or sort monitoring regions 161/162 in the microfluidic chip 100. In various embodiments, the light source 212 can be provided as one more monochromatic light sources, one or more polychromatic light sources, or a mixture of mono- and polychromatic light sources. While the beam-shaping optic 217 is depicted as a micro-lens array in FIG. 12, the beam-shaping optic 217 can include one or more lenses, mirrors, filters including optical elements that can segment or split a beam into beamlets.

Particles flowing in the microchannel interact with the illumination light and produce an optical signal. The optical signal is collected by the microlens array 217 and is projected towards the light separation system 205. The light passes through the spectrally selective reflector to other beam-shaping optics of the detection system 220 including an optical filter 225 that performs spectral selection (or “clean-up”) on the optical signal and a light collector 224 such as a microlens array or diffractive element that focuses the light in preparation for receipt by the detector 223. In some embodiments, the optical filter 225 can include a bandpass filter centered at 530 nm. The detection system 220 can perform spectral selection and detection using an array of elements in some embodiments. Examples of optical signals that may be produced in optical particle analysis, cytometry and/or sorting when a beam intersects a particle include, without limitation, optical extinction, angle dependent optical scatter (forward and/or side scatter) and fluorescence. Optical extinction refers to the amount of electromagnetic radiation or light that a particle extinguishes, absorbs, or blocks. Angle dependent optical scatter refers to the fraction of electromagnetic radiation that is scattered or bent at each angle away from or toward the incident electromagnetic radiation beam. Fluorescent electromagnetic radiation is electromagnetic radiation that is absorbed and/or scattered by molecules associated with a particle or cell and re-emitted at a different wavelength. In some instances, fluorescent detection may be performed using intrinsically fluorescent molecules.

In embodiments illustrated by FIG. 12, the microlens array 224 focuses the light into another beam-shaping optics of the detection system in the form of an optical fiber bundle or array 226. In some embodiments, a separate optical fiber in the array 226 is associated with each element of the microlens array 224. The optical fiber array 226 carries the light to sensors of the detector 223. In some embodiments, the detector 223 can include a charge-coupled device (CCD), and light from individual interrogation regions 113 or sort monitoring regions 161/162 can be directed to distinct pixels or groupings of pixels within the CCD. In some embodiments, the detector 223 can include photo-multiplier tubes (PMTs), such as silicon PMs, arranged in a one-dimensional or two-dimensional array such that light from individual interrogation regions 113 or sort monitoring regions 161/162 is directed to distinct PMs in the array. In some embodiments, fiber optic scrambling or other cross-talk reduction techniques can be employed to reduce the amount of unwanted light that reaches each sensor of the detector 223 such as the cross-talk mitigation techniques described in U.S. Pat. No. 9,335,247 to Sharpe et al., issued May 10, 2016, the entire contents of which is incorporated herein by reference.

In some embodiments, the electromagnetic source system 210 and detection system 220 can achieve optical excitation and detection through interfacing planar layers and foregoing a large number of optical elements to relay light for excitation and or detection. For example, the light source 212 can include a VCSEL substrate with multiple excitation sources (i.e., VCSELs) that is positioned nearly adjacent to a top surface of the cover layer 131 of the microfluidic chip 100. A detector substrate is also positioned such that excitation light can be delivered to the chip 100 and detection light can be received from the chip using suitable optical ‘transparency’. In some embodiments, a substrate with elements corresponding to both the electromagnetic source system 210 and the detection system 220 can be assembled and positioned in such a manner as to enable particle measurement from within the chip 100.

FIGS. 13A-13F illustrate side views of various embodiments of electromagnetic source systems 210 interacting with the microfluidic chip 100 according to the present disclosure. The embodiments are presented to provide an overview of multiple non-limiting ways that precise illumination of locations within the microfluidic chip (such as interrogation regions 113 or sort monitoring regions 161/162) can be achieved. In FIG. 13A, the light source 212 of the electromagnetic source system 210 includes an array of lasers. The array of lasers can be arranged as a one-dimensional or two-dimensional array. In some embodiments, the array of lasers can include vertical-cavity surface-emitting lasers (VCSEL) combined with collimation and focusing optics (i.e., the beam-shaping optics 214) to match the illumination spatial profile to the spatial geometry of the pattern 144 of particle processing units in the microfluidic chip 100. The array of lasers can be mounted in a single module in some embodiments. In one embodiment, the array of lasers can include the VCSEL laser array with gallium nitride (GaN) sources arranged in a 16×16 square grid (256 total sources) such as the array described in the scientific journal article entitled “Watt-class blue vertical-cavity surface-emitting laser arrays” by Masaru Kuramoto et al., Applied Physics Express, 12, 091004, 2019, the entire contents of which is incorporated herein by reference.

FIG. 13B illustrates the light source 212 including multiple separate lasers arranged into an array. The lasers can be packaged separately and brought into close proximity for arrangement into a pattern that complements the pattern 144 of the particle processing units.

FIG. 13C illustrates a light source including a shaped laser beam 212a. The laser beam 212a illuminates a beam-shaping optic 214 in the form of a segmented mirror in this embodiment. The segmented mirror can be a static optical element that produces an array of laser beamlets in a one-dimensional or two-dimensional pattern that complements the pattern 144 of particle processing units in the microfluidic chip. In some embodiments, the beam-shaping optic 214 can be a segmented refractive element (e.g., a prism or grating) rather than a mirror.

FIG. 13D illustrates a similar arrangement to FIG. 12 with the omission of the beam-shaping optic 214 placed between the light source 212 and the light separation system 205. In this embodiment, the light source 212 can include a collimated laser beam that is not separated into beamlets until it passes through the beam-shaping optic 217 in the form of a lenslet array. The lenslet array generates focused beamlets in either one dimension or two dimensions to illuminate the interrogation regions 113 or the sort monitoring regions 161/162.

In FIG. 13E, the light source includes an array of illumination optical fibers 212b. Each illumination optical fiber 212b is associated with an element of the beam-shaping optic 214 such as a single microlens in a microlens array. The beam-shaping optic 214 can collimate the light from the illumination optical fiber 212b in some embodiments. The illumination optical fibers 212b can perform the illumination function with similar collimation, reflection, and illumination characteristics as the embodiment shown in FIG. 13A. The illumination light reflects from the light separation system 205 and is directed through the beam-shaping optic 217 that can include a microlens array. Light from each fiber 212b is focused to illuminate a respective interrogation region 113 or sort monitoring region 161/162.

FIG. 13F illustrates an embodiment wherein the light source includes a shaped light beam 212a such as a shaped laser beam. For example, the light source 212a can include a laser beam that has been expanded to fill the aperture of the beam-shaping optic 214. The beam-shaping optic 214 can include a dynamic beam splitter that divides the shaped light beam into segments that correspond to individual interrogation regions 113 or sort monitoring regions 161/162 in the microfluidic chip 100. The dynamic beam splitter (such as a dynamic laser splitting element) can shape or steer portions of the light source 212 toward the microfluidic chip stack. The beam splitter can utilize dynamic technologies such as digital light processing (DLP), digital micromirrors, micro-electromechanical systems (MEMS), or other dynamic diffractive, refractive, or reflective techniques to divide the shaped light beam into segments. In addition to splitting or sectioning the light source 212 into beamlets, the dynamic beam-shaping optic 214 can move beamlets to aid with alignment, particle tracking, focusing, or other methods for increased accuracy and precision in measurement.

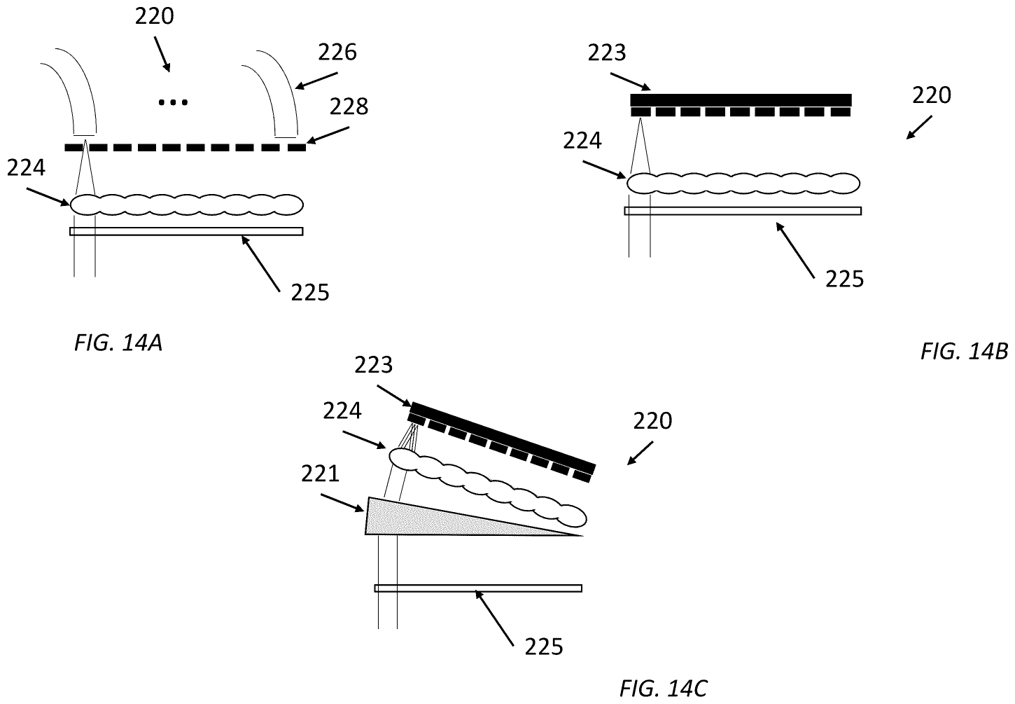

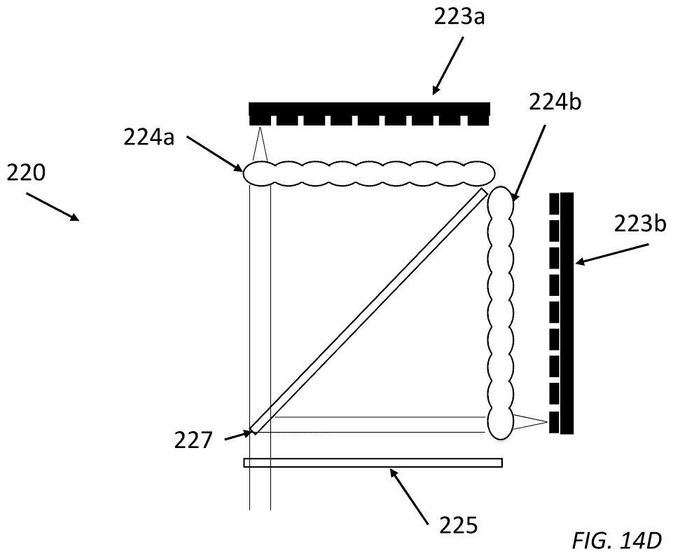

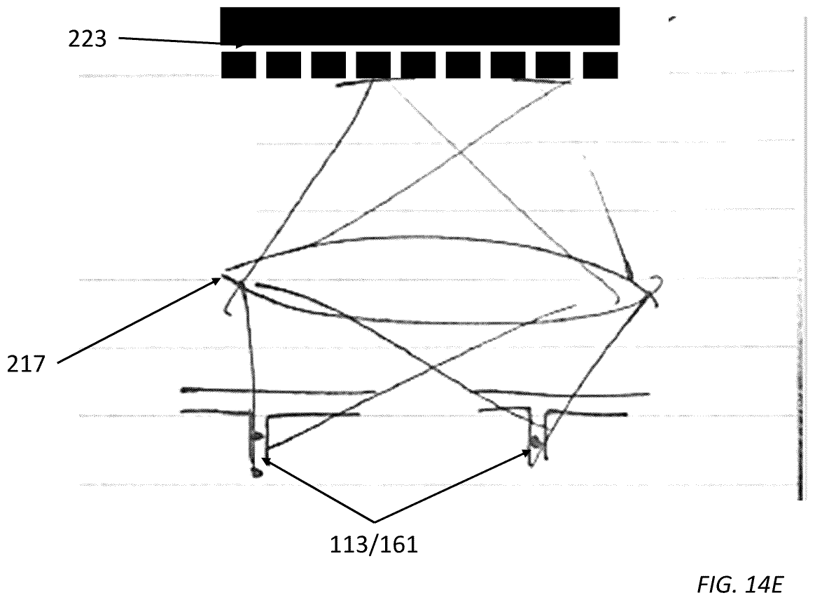

FIGS. 14A-14D illustrate various embodiments of detection systems 220 that are compatible with systems and methods taught herein. In each of FIGS. 14A-14D, detected light from particles arrives at a bottom surface of a spectral selection element 225 from the light separation device 205. The spectral selection element 225 cleans up the light by removing stray light at wavelengths that are not of interest including, for example, the wavelength of the illumination light in some embodiments.

In FIG. 14A, light emitted or reflected from an interrogation region of the microfluidic chip passes through one or more beam-shaping optics 224 where it is focused. The beam-shaping optic 224 can include a microlens array or diffractive elements. The focused light then passes through a spatial selection element 228. The spatial selection element 228 can include pinholes, knife-edges, or other optical elements that accept desired light (or block a portion of the received light that is not desired). The spatial selection element 228 can ensure clean coupling of the light into a first end of a bundle or array of optical fibers 229. A second end of the optical fibers 226 is coupled to the detector 223 (not shown). The detector 223 can include multiple detection elements such as individual photomultiplier tubes (PMTs) or individual pixels in a CCD. The fibers 226 can be associated with individual detection elements on a one-to-one basis in some embodiments. In some embodiments, each fiber 226 can transmit light to multiple detection elements although each detection element can be associated with one fiber 226 to improve isolation between received light from different particle processing units.

FIG. 14B illustrates the detection system 220 where light received from the interrogation region(s) of the microfluidic chip 100 passes through the spectral selection element 225 and the beam-shaping optic 224. The beam-shaping optic 224 focuses light directly onto individual detection elements of a detector 223 (which may also be referred to as a sensor array). While a spatial selection element 228 is not shown in FIG. 14B, such an element can be used in this embodiment.

In FIG. 14C, received light passes through the spectral selection element 225, which blocks unwanted wavelengths, before passing through a spectral separator 221 such as a grating or prism. The spectral separator 221 can disperse the light according to wavelength so that received light of different wavelengths is directed spatially to separate detection elements or to different locations on a same detection element. In this way, the spectral separator 221 can act as a combined spectral and spatial selection element because it directs certain portions of the received light from particles to an appropriate detector element. As shown in FIG. 14C, the light beam is split into two focus points on the detector 223 such that locations of the two focus points are separated on the corresponding detection element, which has an extended receiving area.

FIG. 14D illustrates an embodiment of the detection system 220 including separate detectors 223. Received light from interrogation regions 113 or sort monitoring regions 161/162 is directed to a beam separator 227. The beam separator 227 can divide each received light beam into two beams that proceed in different directions. The beam separator 227 can separate the received light based upon spectral characteristics of the light (e.g., transmitting light below a cutoff frequency of wavelength and reflecting light at or above the cutoff frequency or wavelength) in some embodiments. In some embodiments, the beam separator 227 can divide light based upon properties such as polarization. In some embodiments, the beam separator 227 can divide the received light without regard to properties of the light such as in the case of a 50/50 partially-reflective beam splitter that divides the received light into two beams of equal intensity. One divided beam of received light passes through a first beam-shaping optic 224a and is focused onto a first detector 223a along a first path, while the other divided beam of received light passes through a second beam shaping optic 224b and is focused onto a second detector 223b.

In some embodiments, the detection system 220 can separately detect light emanating from a single interrogation region 113 or sort-monitoring region 161/162 at different angles. For example, angular light collection geometries can differ between scattering and fluorescence measurements. This fact can be exploited to identify particle properties (and ultimate the particle's identity or type) based upon the difference in light that is scattered vs. fluoresced as measured from different angular positions according to light-particle interactions described by Mie or Rayleigh theory.

As described above, the beam-shaping optics 217 can include a microlens array where microlenses of the array are associated one-to-one with interrogation regions 113, sort-monitoring regions 161/162, or both. In some embodiments, microlenses of the array can be associated with more than one interrogation region 113, sort-monitoring region 161/162, or both. For example, each microlens may be associated with two, three, four, five, six, seven, or eight light emitting regions such as interrogation regions 113 and sort-monitoring regions 161/162. In some embodiments, the beam-shaping optics 217 can include a lens that is appropriately formatted to collect light from multiple interrogation regions 113, sort-monitoring regions 161/162, or both as shown in FIG. 14E. The lens can function to accomplish one or more of collecting, collimating, and focusing light received from particles in multiple interrogation regions 113 or sort monitoring regions 161/162. The lens can focus the light onto individual elements (e.g., individual pixels or individual photomultiplier tubes) of the detector 223. In some embodiments, additional lenses or other beam-shaping optics can be used to relay light from the chip 100 to the detector 223. Techniques for cross-talk mitigation can be used as described above. The beam-shaping optics 217 including a large lens to collect light from multiple locations on the chip is appropriate for use with other embodiments described in relation to FIGS. 14A-14D. In some embodiments, the beam-shaping optics 217 can focus illumination light from the electromagnetic source system 210 onto separate interrogation regions 113, sort-monitoring regions 161/162, or both.

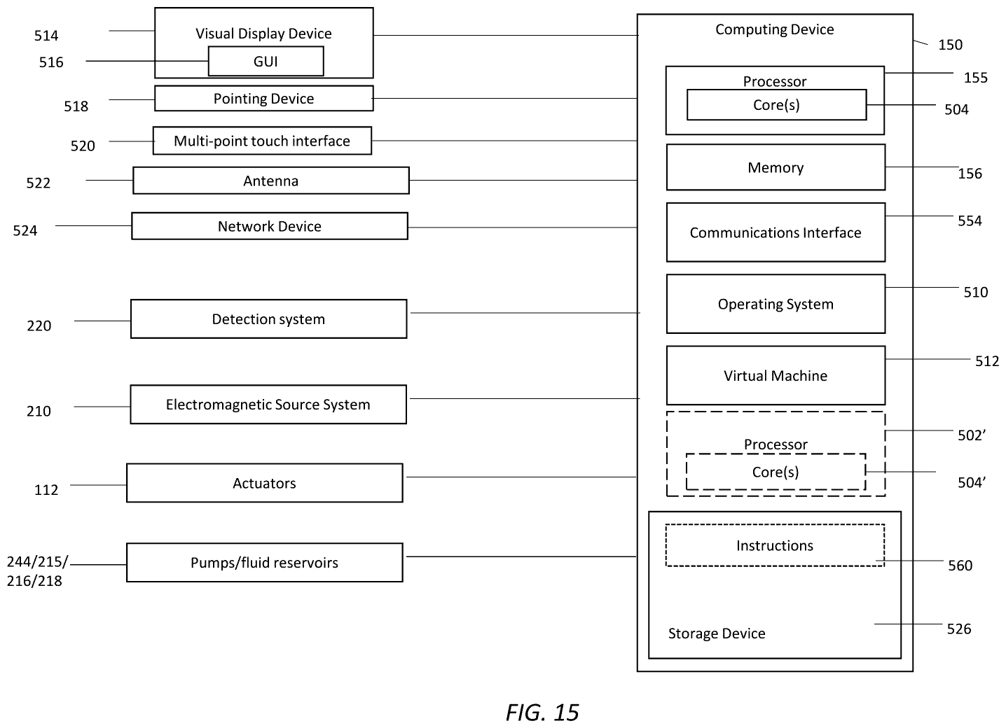

FIG. 15 is a block diagram of the computing device 150 suitable for use with embodiments of the present disclosure. The computing device 150 may be, but is not limited to, a smartphone, laptop, tablet, desktop computer, server, or network appliance. The computing device 150 can include a field-programmable gate array (FPGA) in some embodiments. The computing device 150 can include an application-specific integrated circuit (ASIC) in some embodiments.

The computing device 150 includes one or more non-transitory computer-readable media for storing one or more computer-executable instructions or software for implementing the various embodiments taught herein. The non-transitory computer-readable media may include, but are not limited to, one or more types of hardware memory (e.g., memory 156), non-transitory tangible media (for example, storage device 526, one or more magnetic storage disks, one or more optical disks, one or more flash drives, one or more solid state disks), and the like. For example, memory 156 included in the computing device 150 may store computer-readable and computer-executable instructions 560 or software (e.g., instructions to process particles as in the method 1100 described below) for implementing operations of the computing device 150. The computing device 150 also includes configurable and/or programmable processor 155 and associated core(s) 504, and optionally, one or more additional configurable and/or programmable processor(s) 502′ and associated core(s) 504′ (for example, in the case of computer systems having multiple processors/cores), for executing computer-readable and computer-executable instructions or software stored in the memory 156 and other programs for implementing embodiments of the present disclosure. Processor 155 and processor(s) 502′ may each be a single core processor or multiple core (504 and 504′) processor. Either or both of processor 155 and processor(s) 502′ may be configured to execute one or more of the instructions described in connection with computing device 150.

Virtualization may be employed in the computing device 150 so that infrastructure and resources in the computing device 150 may be shared dynamically. A virtual machine 512 may be provided to handle a process running on multiple processors so that the process appears to be using only one computing resource rather than multiple computing resources. Multiple virtual machines may also be used with one processor.

Memory 156 may include a computer system memory or random access memory, such as DRAM, SRAM, EDO RAM, and the like. Memory 156 may include other types of memory as well, or combinations thereof.

A user may interact with the computing device 150 through a visual display device 514, such as a computer monitor, which may display one or more graphical user interfaces 516. The user may interact with the computing device 150 using a multi-point touch interface 520 or a pointing device 518.

The computing device 150 may also include one or more computer storage devices 526, such as a hard-drive, CD-ROM, or other computer readable media, for storing data and computer-readable instructions 560 and/or software that implement exemplary embodiments of the present disclosure (e.g., applications). For example, exemplary storage device 526 can include instructions 560 or software routines to enable data exchange with, or operational control of, detectors 223 or light sources 212. The storage device 526 can also include instructions 560 or software routines to execute particle processing methods such as method 1100.

The computing device 150 can include a communications interface 554 configured to interface via one or more network devices 524 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In example embodiments, the computing device 150 can include one or more antennas 522 to facilitate wireless communication (e.g., via the network interface) between the computing device 150 and a network and/or between the computing device 150 and components of the system such as the electromagnetic source system 210, the detection system 220, or pumps operatively connected to fluid reservoirs 215/215/216/218. The communications interface 554 may include a built-in network adapter, network interface card, PCMCIA network card, card bus network adapter, wireless network adapter, USB network adapter, modem or any other device suitable for interfacing the computing device 150 to any type of network capable of communication and performing the operations taught herein.

The computing device 150 may run an operating system 510, such as versions of the Microsoft® Windows® operating systems, different releases of the Unix® and Linux® operating systems, versions of the MacOS® for Macintosh computers, embedded operating systems, real-time operating systems, open source operating systems, proprietary operating systems, or other operating system capable of running on the computing device 150 and performing the operations taught herein. In exemplary embodiments, the operating system 510 may be run in native mode or emulated mode. In an exemplary embodiment, the operating system 510 may be run on one or more cloud machine instances.

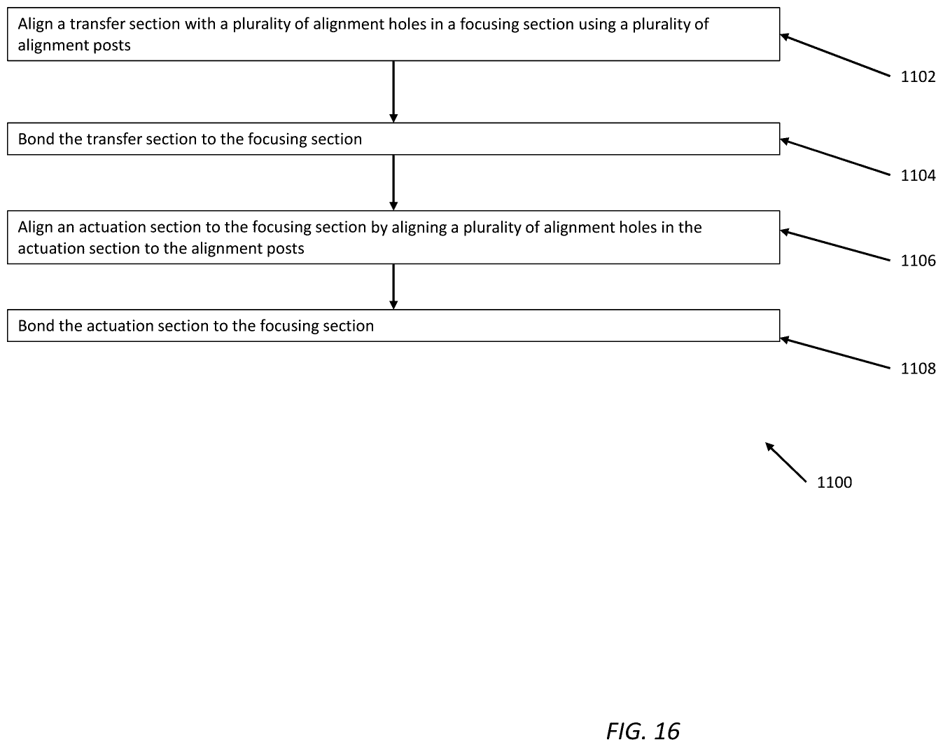

FIG. 16 illustrates a flowchart for a method 1100 of fabricating the microfluidic chip according to some embodiments taught herein. The method 1100 includes aligning the transfer section 110 with the plurality of alignment holes 315 in the particle focusing section 120 using the plurality of alignment posts 310 (step 1102). The method 1100 includes bonding the transfer section 110 to the particle focusing section 120 (step 1104). The method 1100 includes aligning the actuation section 130 to the particle focusing section 120 by aligning the plurality of alignment holes 315 in the actuation section 130 to the alignment posts 310 (step 1106). The method 1100 includes bonding the actuation section 130 to the particle focusing section 120.

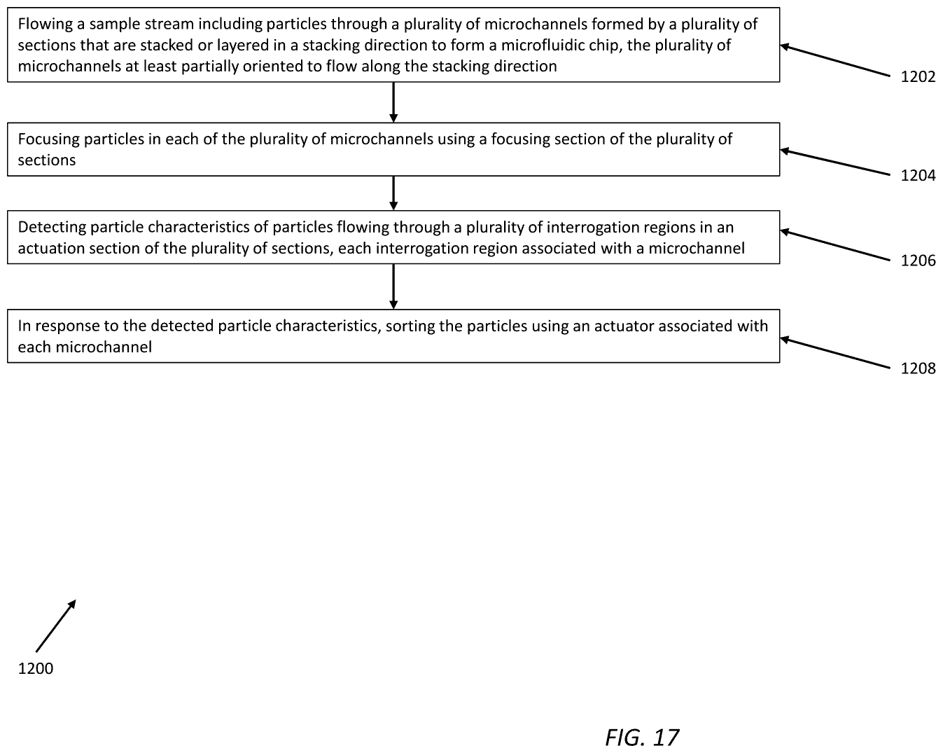

FIG. 17 illustrates a flowchart for a method 1200 of processing particles using the microfluidic chip 100 according to some embodiments taught herein. The method 1200 includes flowing the sample stream including particles 50, 60 through the plurality of microchannels 114 formed by the plurality of sections 110, 120, 130 that are stacked or layered in a stacking direction 107 to form the microfluidic chip 100 (step 1202). The plurality of microchannels 114 are at least partially oriented to flow along the stacking direction 107. The method 1200 includes focusing particles 50, 60 in each of the plurality of microchannels using the particle focusing section 120 of the plurality of sections 110, 120, 130 (step 1204). The method 1200 also includes detecting particle characteristics of particles 50, 60 flowing through the plurality of interrogation regions 113, which is some embodiments are located in the actuation section 130 of the plurality of sections (step 1206). Each interrogation region 113 is associated with a microchannel 114. For example, detecting the particle characteristics can include illuminating the particles 50, 60 in the interrogation region 113 using the electromagnetic source system 210 that focuses light through the cover layer 131 of the actuation section 130. The particles 50, 60, in turn emit or scatter light or extinguish or absorb the illumination light, and this produces a light signal corresponding to the particle characteristic that is detectable by the detection system 220. In some embodiments, the particles 50, 60, may flow through multiple microsorters in series (on one layer) with multiple serial actuators 112. The method 1200 includes sorting the particles in response to the detected particle characteristics using the actuator 112 associated with each microchannel 114 (step 1208). For example, the computing system 150 can receive signals from the detection system 220 and determine whether the signals correspond to the presence or absence of the particle characteristic in the particle 50, 60. If the detected particle characteristic indicates that the particle is a desired particle 60 that should be sorted into the keep channel 118, the computing system 150 controls the actuator 112 to divert the particle 60 into the keep channel 118.

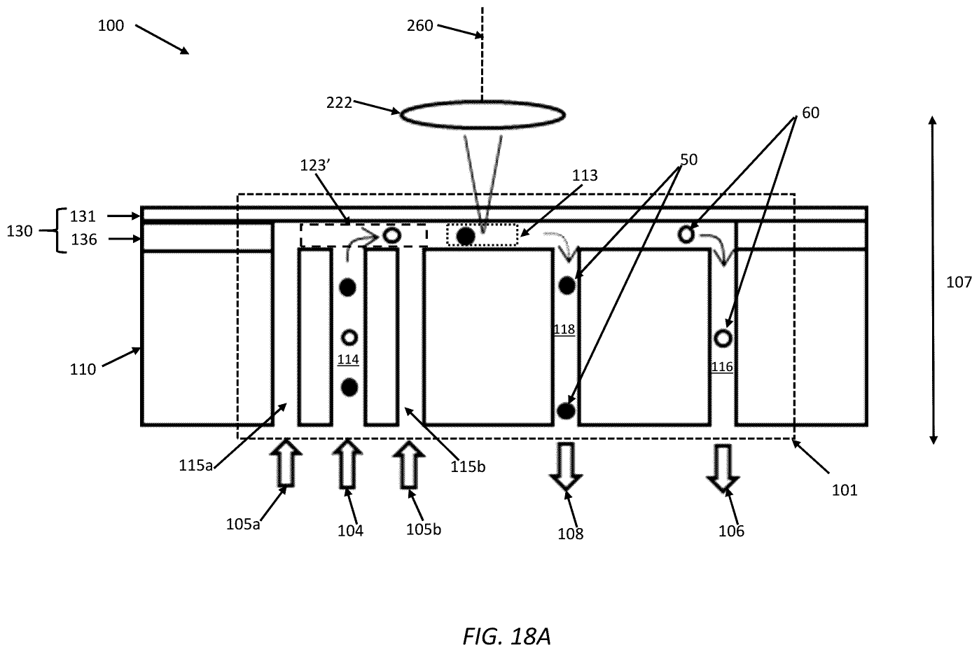

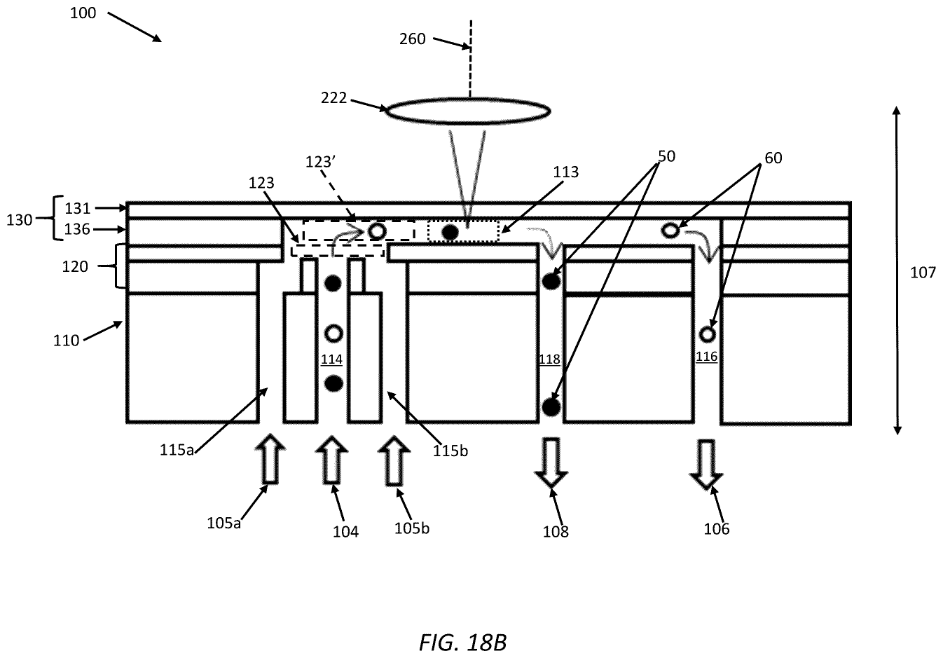

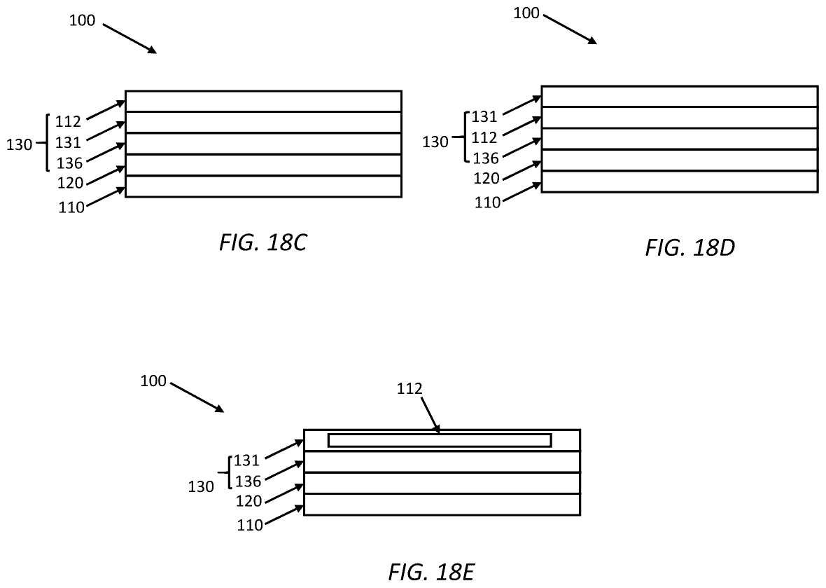

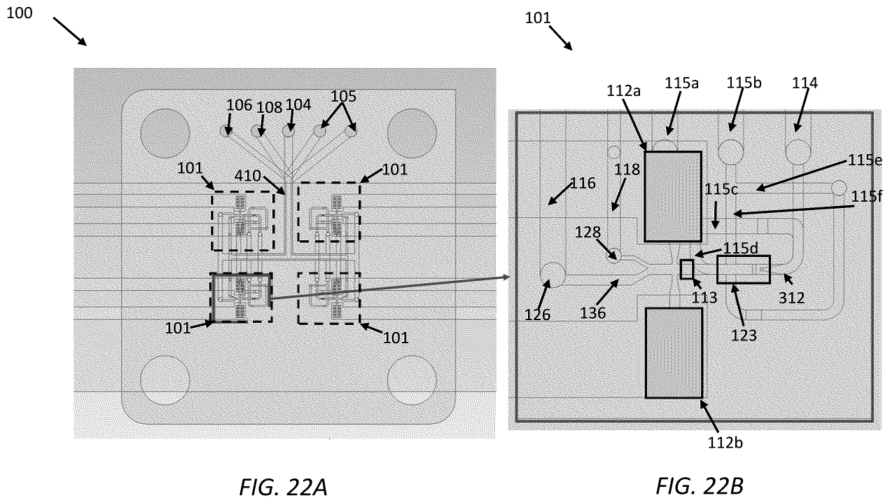

FIG. 18A illustrates a cross-sectional view through a schematic representation of a microfluidic chip 100 according to the present disclosure. Hydrodynamic focusing occurs in part during transition from a first direction in relation with optical illumination and detection elements. The microfluidic chip 100 is an embodiment of a ‘right-right’ particle sorting scheme. As illustrated in FIG. 18A, sample fluid including particles 50, 60 flow upwards through the transfer section 110 on the fluid input path 104 into the main microchannel 114 while sheath fluid flows through the transfer section 110 on sheath fluid flow input paths 105a, 105b into respective sheath channels 115a, 115b. The sample fluid including particles contacts sheath fluid and is focused by the sheath fluid in the particle focusing region 123′. The hydrodynamic focusing occurs in part during transition from a first direction (e.g., a vertical direction, a direction in parallel to an optical axis 260, and/or a direction along the staking direction 107) to a second direction (e.g., a horizontal direction, a direction perpendicular to an optical axis 260, and/or a direction the staking direction 107) and in part due to the addition of sheath fluid by the sheath channel 115b after the particle transitions to second direction. The actuator section 130 can include a processed particle layer 136 just below the cover layer 131. The fluid distribution layer 136 can form a horizontal channel (i.e., flowing perpendicular to the stacking direction 107) and is fluidically coupled to the output channels 116, 118. The flow direction of particles in the processed particle layer 136 is normal to the optical axis 260 used by illumination or detection systems at or near the interrogation region 113. The particles flow into the interrogation region 113 where they can be detected using a detection system such as the optical detection system using lens 222. Based upon the detected signal (e.g., an optical fluorescence, scattering, emission, or extinction) from the particle in the interrogation region 113, a control system such as the computing device 150 can identify whether the particle is a desired particle 60 or an undesired particle 50. When a desired particle 60 is detected, the actuator 112 (e.g., as illustrated in FIG. 22B) can take no action such that the desired particle 60 passes on a natural flow path to the first output channel 106. When an undesired particle 50 is detected, the actuator 112 (e.g., as illustrated in FIG. 22B) is actuated to divert the particle to the second output path 108. In some embodiments, the second output channel 108 can be connected with a natural flow path, and the first output channel 106 can be a diverted flow channel. The actuator 112 (e.g., as illustrated in FIG. 22B) can be actuated to divert the desired particle 60 to the first output chancel 106. The actuator 112 can take no action such that the undesired particle 50 passes on the natural flow path to the second output channel 108.

FIG. 18B illustrates a cross-sectional view through a schematic representation of the microfluidic chip 100 according to the present disclosure in relation with optical illumination and detection elements. As illustrated in FIG. 18B, the microfluidic chip 100 includes the particle focusing section 120 as compared with the microfluidic chip 100 of FIG. 18A. The particle focusing section 120 allows hydrodynamic focusing to occur in the particle focusing region 123 along the stacking direction 107, and then transition from a vertical direction to a horizontal direction where all or a majority of fluid flows horizontally (i.e., transverse to the stacking direction). In some embodiments, during transition from a vertical direction to a horizontal direction, additional hydrodynamic focusing can occur in the particle focusing region 123′.

FIGS. 18C-18E illustrate a cross-sectional view through a schematic representation of a microfluidic chip 100 having the actuator (s) 112 at various locations according to the present disclosure. One or more actuators 112 can be located throughout the actuation section 130. In some embodiments, The actuator(s) 112 can be located above, on or between layers, below a top layer (e.g., the cover layer 131), or some combination thereof. For the case of being above, within, or just below the top layer (such that this layer may be optically transparent or partially transparent), a mechanism can be used which may take the form of an electrode layer which is positioned in such a way that acoustic energy can interact with particles from within a chosen microfluidic channel of the actuation section 130 (e.g., the horizontal channel subsection 146). For example, see FIG. 5.

For the case of being below a substrate, one or more actuators 112 may interact with particles (e.g., in the horizontal channel subsection 146) by being in communication, and/or by using a via or other channel that allows connection through multiple layers. The actuator(s) 112 can be piezoelectric actuators, for example, a piezo-driven pin that interfaces with a membrane layer, which can be sufficiently flexible to allow deflection of the actuator 112 to impart a pulse on a channel of the actuation section 130 to in turn allow a particle to be deflected. Such a membrane layer may be the same, or a different material to the microfluidic chip 100, such as a polymer, glass, metal, or other hybrid or combination material layer.

There are numerous other ways that particles can be actuated (i.e. sorted, or for that matter, anti-sorted), and this may include non-limiting examples of valves, pumps, acoustic elements, thermal elements, expansion elements, bubble generators, vibration devices, and the like. These devices may be positioned on, within, or through multiple layers of the microfluidic chip 100. Further, the actuator(s) 112 may be a part of the microfluidic chip 100, or may interface with the microfluidic chip 100 as desired for a particular application, and/or an application where expense and complexity needs to be considered).

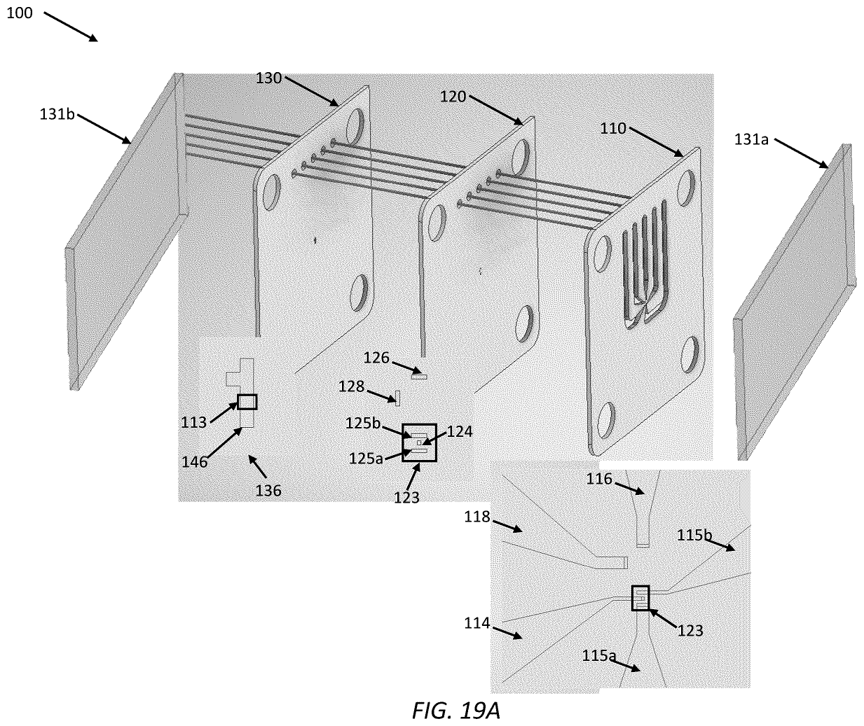

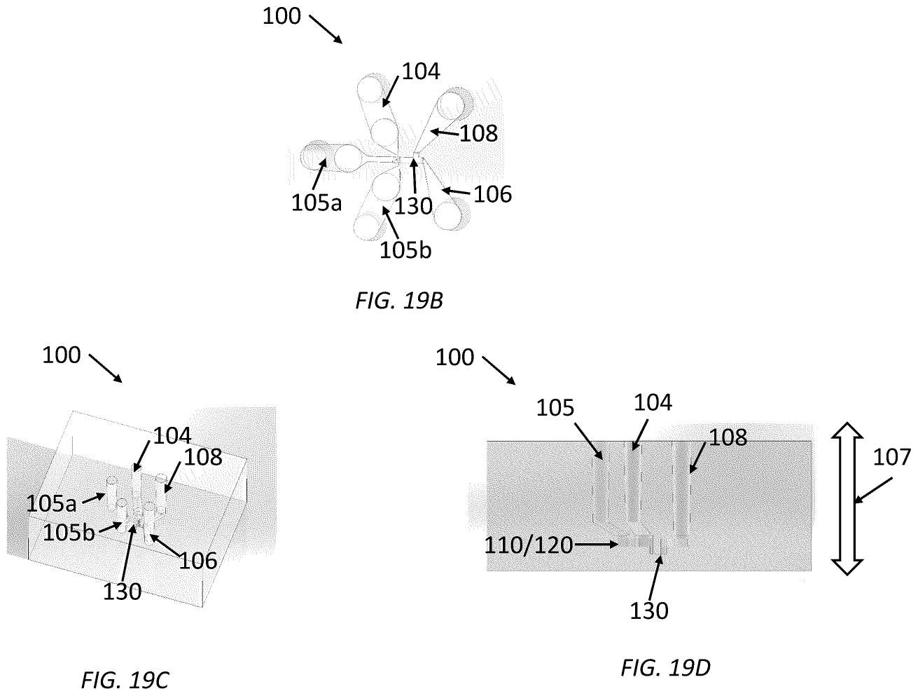

FIG. 19A illustrates an exploded view through a schematic representation of the microfluidic chip 100 according to the present disclosure. The microfluidic chip 100 includes the transfer section 110, the particle focusing section 120 and the actuation section 130. Sandwiching the transfer section 110, the focusing section 120 and the actuation section 130 are cover sections 131. One cover section 131a is adjacent to or in direct or indirect contact with the transfer section 110 and the other cover section 131b is adjacent to or in direct or indirect contact with the actuation section 130. The cover sections 131 can act to seal the microfluidic chip 100. The cover sections 131 can also be formed of a suitable material to avoid interference with optical measurement, optical detection and optical interrogation of particles in the microfluidic chip 100.

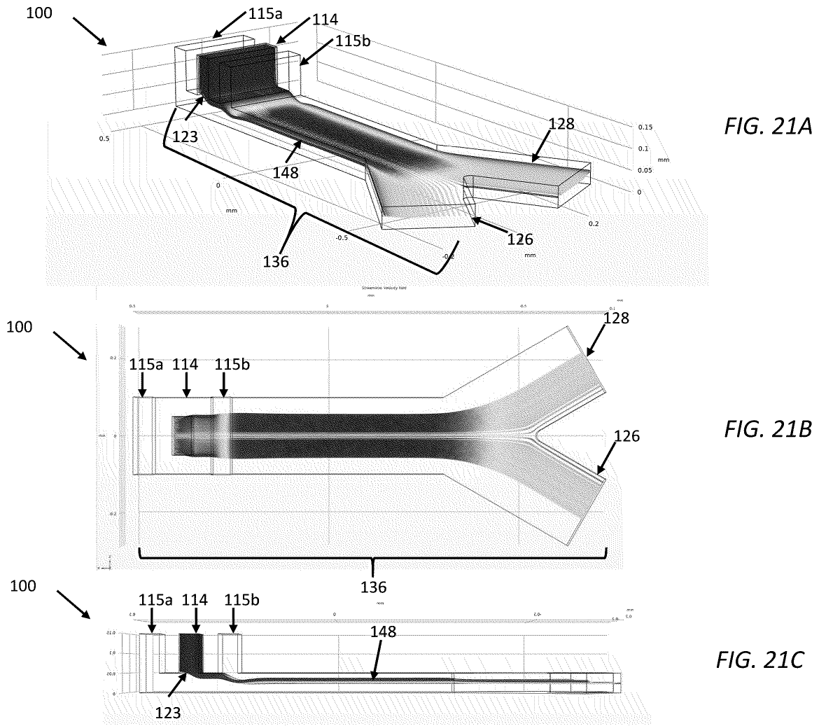

The transfer section 110 can transport fluids into and out of the multiple microfluidic channels in the microfluidic chip 100. For example, within the particle focusing section 120 are multiple particle focusing regions 123 to focus particles, for example, at least one particle focusing region for each of the particle processing units 101. One example particle focusing region 123 is illustrated in FIG. 19 and further details of the particle focusing region 123 are discussed below in relation to FIGS. 21A-21C. The particle focusing region 123 includes a sample inlet port 124 for introduction of sample fluid including particles from the sample channel 114 into the particle focusing region 123 in the focusing section 120. The particle focusing region 123 also includes sheath inlets 125a, 125b, which are fluidically coupled to sheath inlets 115a, 115b, respectively. Downstream of the particle focusing region 123 is an outlet 128 fluidically coupled to an output channel 118, for example a waste or keep output channel and an outlet 126 fluidically coupled to an output channel 116, for example a waste or keep output channel.

The actuation section 130 includes the processed particle layer 136. In some embodiments, the processed particle layer 136 includes a horizontal channel subsection 146 downstream of each of the focusing regions 123. The horizontal channel subsection 146 includes an interrogation region 113 in which particles are interrogated as discussed herein. Downstream of the interrogation region 113 are output channels 116, 118 that are fluidically coupled to horizontal channel subsection 146 via the outlets 126, 128.

Each cover section 131 can enable observation, detection, or both observation and detection of particles flowing within the chip 100. Each cover section 131 can include a window or window-like layer in some embodiments to provide a transparent optical interface to the fluid that lies below a corresponding cover section 131. The cover sections 131 can act as a liquid-proof barrier, i.e., the cover sections 131 can prevent the movement of water or oil from inside the chip 100 to outside or vice versa. In some embodiments, the cover sections 131 can form a portion of one or more fluidic channel pathways in which fluid flows. Other features such as electrodes may also be applied to, integrated into, or included on the cover section 131. In some embodiments, the cover section 131b close to the actuation section 130 can include the actuators 112 in some embodiments as described in greater detail above. The cover sections 131 can be formed of one or more materials that are configured to provide high transmission of wavelengths of electromagnetic radiation that are of interest to a particular application (e.g., wavelengths of excitation light, scattered light, or fluorescence). In some embodiments, the cover section 131 can allow transmission of light at wavelengths in a range from the ultraviolet (UV) to near infrared (IR) wavelengths or for a range that represents a sub-portion of the range from UV to near-IR depending on design intent.

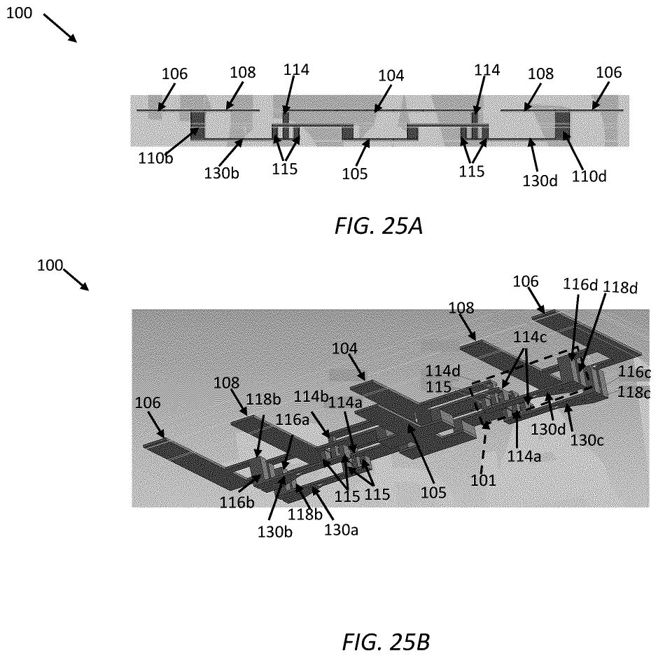

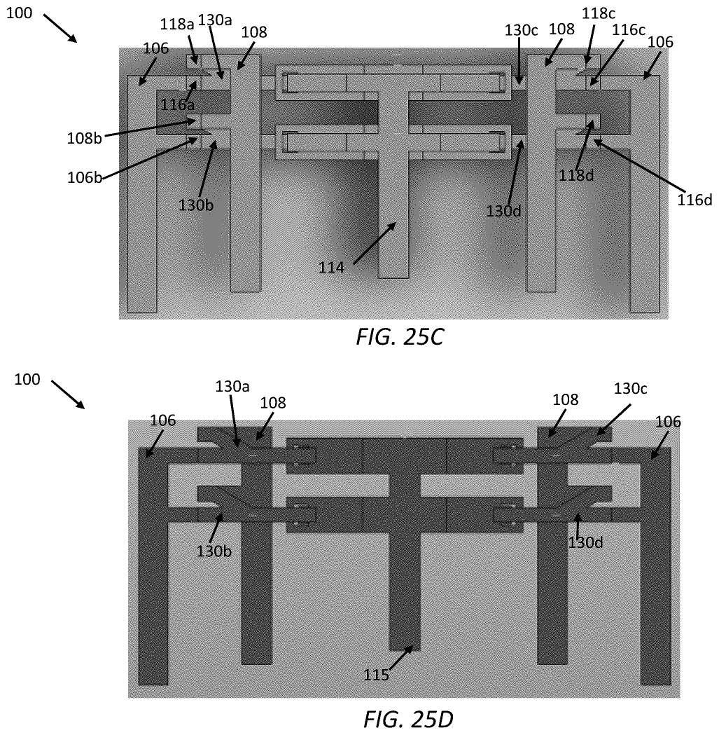

FIG. 19B illustrates a top view through a three-dimensional (3D) schematic representation of the microfluidic chip 100 according to the present disclosure in an illustration. FIG. 19C illustrates a perspective view through a 3D schematic representation of the microfluidic chip 100 of FIG. 19B. FIG. 19D illustrates a partial side view representation of the microfluidic chip 100 of FIG. 19B. As illustrated in FIGS. 19B-19D, the transfer section 110, the particle focusing section 120 and the actuation section 130 are stacked along the stacking direction 107. The actuation section 130 are fluidically coupled to the sample input channel 104, the sheath input channels 105 and the output channels 108. The transfer section 110 and the particle focusing section 120 have the sample input channel 114, the sheath input channels 115 and the output channels 116, 118 (as illustrated in FIGS. 25A-25D). In some embodiments, the transfer section 100 can include the particle focusing section 120. In some embodiments, the actuation section 130 can include the particle focusing section 120 (e.g., as illustrated in FIG. 18A). In some embodiments, the particle focusing section 120 is in a separate section (e.g., as illustrated in FIG. 18A).

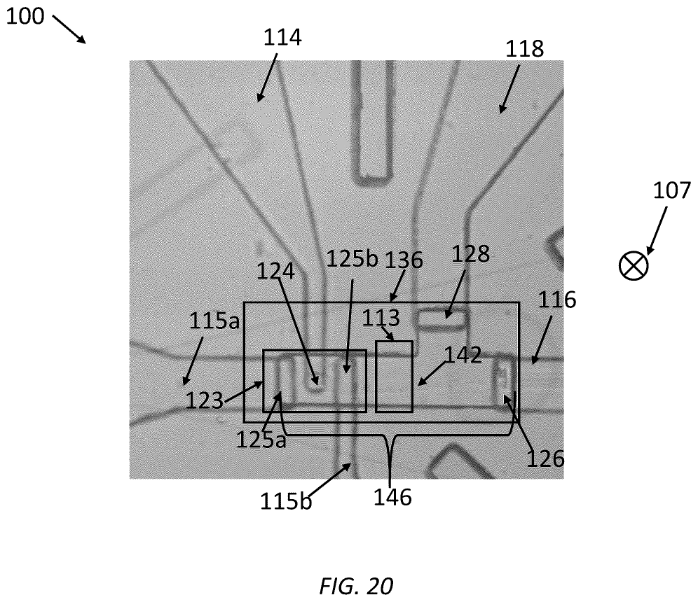

FIG. 20 illustrates a stack image from a top view of the stacked up sections of the fabricated microfluidic chip 100 under operation along the stacking direction 107. The microfluidic chip 100 includes the transfer section 110 having the sample channel 114, sheath channels 115 and output channels 116, 118, the particle focusing section 120 having the particle focusing region 123 and the actuation section 130 having the processed particle layer 136. The particle focusing region 123 includes the sample inlet port 124 for introduction of sample fluid including particles from the sample channel 114 into the particle focusing region 123. The particle focusing region 123 also includes sheath inlets 125a, 125b, which are fluidically coupled to sheath inlets 115a, 115b, respectively. Downstream of the particle focusing region 123 is the outlet 128 fluidically coupled to an output channel 118, for example a waste or keep output channel and an outlet 126 fluidically coupled to the output channel 116, for example a waste or keep output channel. The processed particle layer 136 includes a horizontal channel subsection 146 downstream of the focusing regions 123. The horizontal channel subsection 146 includes an interrogation region 113 in which particles are interrogated as discussed herein. Downstream of the interrogation region 113 are output channels 116, 118 that are fluidically coupled to horizontal channel subsection 146 via the outlets 126, 128. Sample fluid having particles flows into the sample channel 114, and then flows into the particle focusing region 123. Sheath fluid flows into the sheath channels 115, and then flows into the particle focusing region 123. Hydrodynamic focusing occurs in the particle focusing region 123. Focusing of the particles allows particles to be fluidically well controlled, travel in a single file, and to be confined to a fluidic core 142 (e.g., a central fluidic core).

FIG. 21A illustrates a perspective view of a simulation for hydrodynamic focusing in a focusing region as disclosed herein. In the illustrated hydrodynamic focusing structure, focusing of particles in the sample stream occurs during transition of the sample stream from a vertical direction to a horizontal direction and with the addition of sheath fluid in the vertical direction after the transition. FIG. 21B illustrates a top view of the simulation of FIG. 21A.

FIG. 21C illustrates a side view of the simulation. Hydrodynamic focusing can narrow, accelerate, and position a sample fluid from the sample channel 114 to generate a laminar flow 148 using sheath fluid from the sheath channels 115, e.g., by “squeezing” a sample fluid by introducing sheath fluid where the sample fluid is flowing.

As illustrated in FIGS. 21A-21C, sample fluid including particles flow vertically in the sample channel 114 into the particle focusing region 123. Likewise, sheath fluid flows vertically in the sheath channels 115a, 115b into the particle focusing region 123. At the particle focusing region 123, the vertical flow channels for the sheath and sample transition from a vertical direction to a horizontal direction. As illustrated, the sheath fluid from the channel 115a prevents the sample from coming into contact with a wall of the channel to focus the sample in a first vertical direction as the sample transitions from a vertical flow to a horizontal flow. The sheath fluid from the channel 115b focuses the sample in a second vertical direction. In some embodiments, the width of the flow channel can be decreased, leading to horizontal hydrodynamic focusing, for example a horizontal tapering region, and a horizontal control using side sheath channels.

As such, the sample fluid including particles contacts sheath fluid and is focused by the sheath fluid in the particle focusing region 123. The hydrodynamic focusing occurs during transition from a first direction (e.g., a vertical direction) to a second direction (e.g., a horizontal direction) to generate a laminar flow 148 into the distribution layer 136.

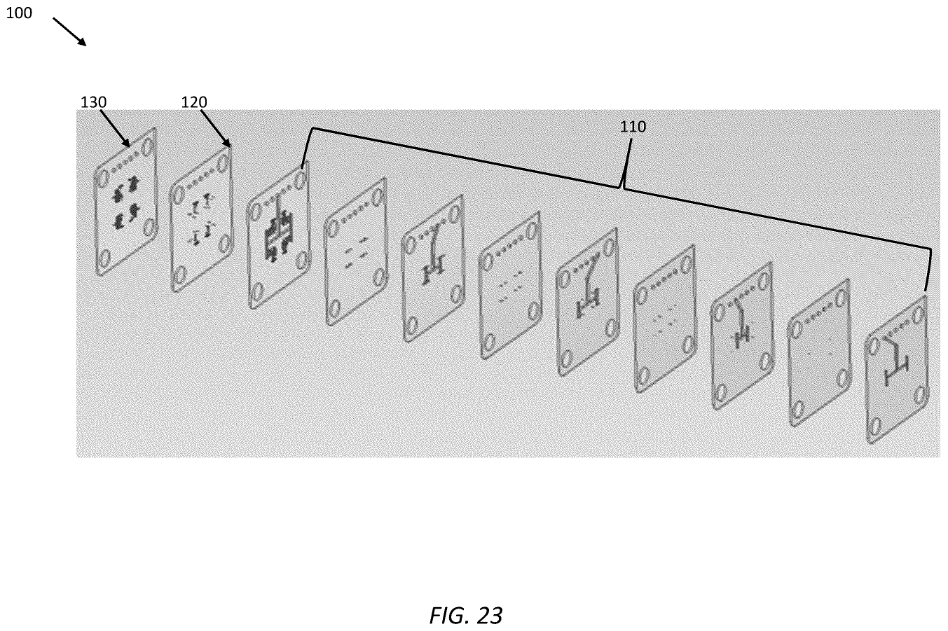

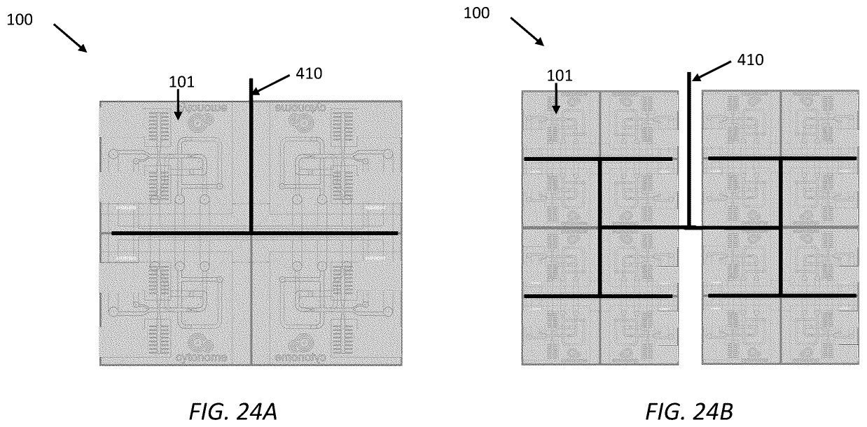

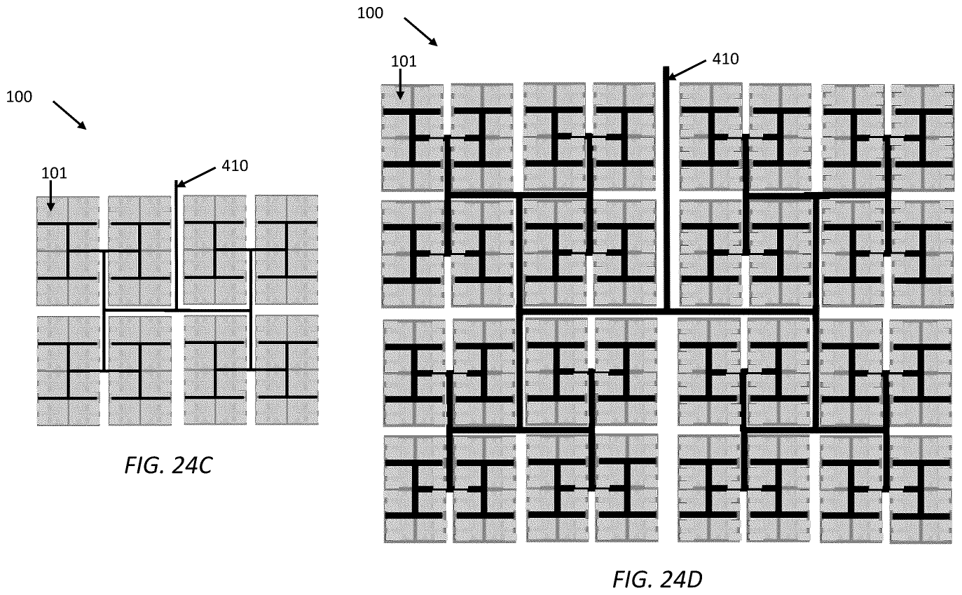

FIG. 22A illustrates a schematic view of the microfluidic chip 100 having 2×2 particle processing units 101 in accordance with various embodiments. FIG. 22A is meant to be illustrative to help illustrate the massively parallel teachings taught herein and is not meant to limit the microfluidic chip 100 to a 2×2 matrix. The transfer section 110 of the microfluidic chip 100 can include a fluidic manifold 400 (as illustrated in FIG. 23) having a microfluidic channel assembly configured to receive particles via a sample fluid input path 104 from a particle source supply (i.e., an off-chip sample fluid reservoir 244), to receive sheath via the sheath fluid input path 105 from the sheath fluid reservoir 215. The microfluidic chip 100 can further include the distribution layer 136 that facilitate dividing or combining of fluidic pathways, as further described with respect to FIG. 22B. The fluidic manifold 400 lays out the various microchannels in a manner to feed all the particle processing units 101 equivalently (i.e., uniform fluid pressure and fluid flow). A main fluid path layout 410 can include multiple microchannels in the same distribution layer or different distribution layers to direct fluid from the sample input path 104, the sheath fluid input paths 105, and the output paths 106, 108, respectively into each particle processing unit 101. Examples of the main fluid path layout 410 are further described with respect to FIGS. 24A-24D.

FIG. 22B illustrates a schematic view of a single particle processing unit 101 of FIG. 21A. Sample fluid including particles flows through the sample channel 114 into the particle focusing region 123 while sheath fluid flows through the sheath channels 115 into the particle focusing region 123. In some embodiments, the sample fluid can enter the particle focusing region 123 via a nozzle-like feature 312. Compared with the microfluidic chip 100 of FIGS. 18-21, the sheath channels 115 have more complex structures. As illustrated in FIG. 22B, the sheath channel 115a is divided into sheath subchannels 115b, 115c. The sheath channel 115b is divided into sheath subchannels 115f, 115e. The sample fluid including particles contacts sheath fluid from the sheath subchannels 115c-115e. The sample fluid can be focused by the sheath fluid via hydrodynamic focusing. Focused particles flow into the distribution layer 136 having the interrogation region 113. Particles within the interrogation region 113 can be detected using a detection system such as the optical detection system using lens 222. Based upon the detected signal (e.g., an optical fluorescence, scattering, emission, or extinction) from the particle in the interrogation region 113, a control system such as the computing device 150 can identify whether the particle is a desired particle 60 or an undesired particle 50. When a desired particle 60 is detected, the actuator 112a can be actuated to divert the desired particle 60 to the first output channel 116 via the outlet 126. When an undesired particle 50 is detected, the actuator 112b can be actuated to divert the particle to the second output channel 118 via the outlet 128. It should be understood that the distribution layer 136 can have other configurations. For example, only one actuator 112 is needed. When a desired particle 60 is detected, the actuator 112 can take no action such that the desired particle 60 passes on a natural flow path to the first output channel 106. When an undesired particle 50 is detected, the actuator 112 is actuated to divert the particle to the second output path 108. In some embodiments, the second output channel 108 can be connected with a natural flow path, and the first output channel 106 can be a diverted flow channel. The actuator 112 can be actuated to divert the desired particle 60 to the first output chancel 106. The actuator 112 can take no action such that the undesired particle 50 passes on the natural flow path to the second output channel 108.

Other particle processing units 101 can perform similar operations. Particles from the first output channel 116 of each particle processing unit 101 can further flow into the first output path 106 to output reservoir 216. Particles from the second output channel 118 of each particle processing unit 101 can further flow into a first output path 108 to output reservoir 218.

FIG. 23 illustrates an exploded view through a schematic representation of the microfluidic chip 100 having 2×2 particle processing units according to the present disclosure. The microfluidic chip 100 includes the transfer section 110, the particle focusing section 120 and the actuation section 130. In some embodiments, sandwiching the transfer section 110, the particle focusing section 120 and the actuation section 130 are cover sections 131, as illustrated in FIG. 19. The particle focusing section 120 includes the sample inlet port 124, the sheath inlet ports 125, and outlet ports 126, 128 (e.g., as illustrated in FIG. 19) for each particle processing unit 101. The particle focusing section 120 can connect actuation section 103 with the transfer section 110 and change a flow direction between the actuation section 103 and the transfer section 110. In some embodiments, the particle focusing section 120 can be non-parallel to the actuation section 130. For example, microchannels in particle focusing section 120 can be non-parallel to a distribution layer 136 having the interrogation region 113. The transfer section 110 includes fluid manifold. The fluid manifold includes a microfluidic channel assembly as described above and the distribution layers 117 that facilitate dividing or combining of fluidic pathways as described with respect to FIGS. 10A-10B.

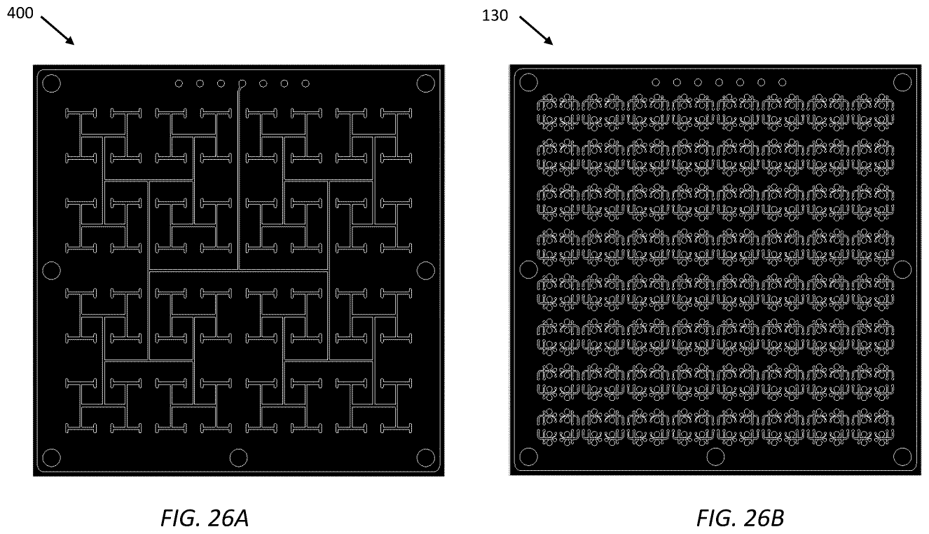

FIG. 24A illustrates a schematic view of the microfluidic chip 100 having the main fluid path layout 410 to feed a 2×2 layout of particle processing units 101 according to the present disclosure. FIG. 24B illustrates a schematic view of the microfluidic chip 100 having the main fluid path layout 410 to feed a 4×4 layout of the particle processing units 101 according to the present disclosure. FIG. 24C illustrates a schematic view of the microfluidic chip 100 having the main fluid path layout 410 to feed a 8×8 layout of the particle processing units 101 according to the present disclosure. FIG. 24D illustrates a schematic view of the microfluidic chip 100 having the main fluid path layout 410 to feed a 16×16 layout of the particle processing units 101 according to the present disclosure. Those familiar in the art would be aware that the scale of this approach can be increased further. The main fluid path layout 410 can feed all the particle processing units 101 equivalently (i.e., uniform pressure and fluid flow). In some embodiments, the main fluid path layout 410 can include multiple microchannels in the same distribution layer or different distribution layers to direct fluid from the sample input path 104, the sheath fluid input paths 105, respectively into each particle processing unit 101. For example, FIG. 26A illustrates a layout of the main fluid path layout 410 for one layer of the microfluidic chip 100 having a 16×16 layout of the particle processing units 101. FIG. 26B illustrates a layout of measurement and actuation sections 130 of the 16×16 layout of particle processing units of FIG. 26A.

FIG. 25A illustrates a partial front view of the microfluidic chip 100 having a plurality of the particle processing units 101 according to the present disclosure. Those skilled in the art that FIG. 25A illustrates a 2×2 layout of the plurality of the particle processing units 101, but this is done to facilitate explanation of the concepts taught herein. FIG. 25B illustrates an isometric view of the microfluidic chip 100 of FIG. 25A. FIG. 25C illustrates a top view of the microfluidic chip 100 of FIG. 25A. FIG. 25D illustrates a bottom view of the microfluidic chip 100 of FIG. 25A. As illustrated in FIGS. 25A-25D, each particle processing unit 101 includes the transfer section 110, the particle focusing section 120 and the actuation section 130. The transfer section 110 and the particle focusing section 120 have the sample input channel 114, the sheath input channels 115 and the output channels 116, 118. The actuation section 130 is also illustrated and includes the processed particle layer 136. In some embodiments, the actuation section 130 can include the particle focusing section 120 (e.g., as illustrated in FIG. 18A). In some embodiments, the transfer section 100 can include the particle focusing section 120. In some embodiments, the particle focusing section 120 is in a separate section (e.g., as illustrated in FIG. 18A). The sample fluid input path 104 has a main fluid pathway in a vertical direction and at some point branches into a plurality of channels, for example in a horizontal direction to supply each particle processing unit. In some embodiments, there may be more than one sample fluid input path 104 depending on the number of particle processing units in the microfluidic chip. To facilitate explanation, in FIGS. 25A-25D the sample fluid input path 104 branches into four branched fluid pathways in a horizontal direction (as illustrated in FIG. 25C), one for each of the particle processing units 101. Each branched fluid pathway connects the sample input chancel 114 that directs the sample fluid flow into a focusing structure, which in the illustrated embodiment is one or more layers in the actuation section 130. Each of the sheath fluid input paths 105 has a main fluid pathway initially a vertical direction and in the in the focusing structure transition to a horizontal direction (as illustrated in FIG. 25D). The actuation section 130 also includes the output paths 106, 108 downstream of the focusing structure. An example illustration of the focusing structure suitable for use with FIGS. 25A-25D can be found in FIGS. 20-21C.

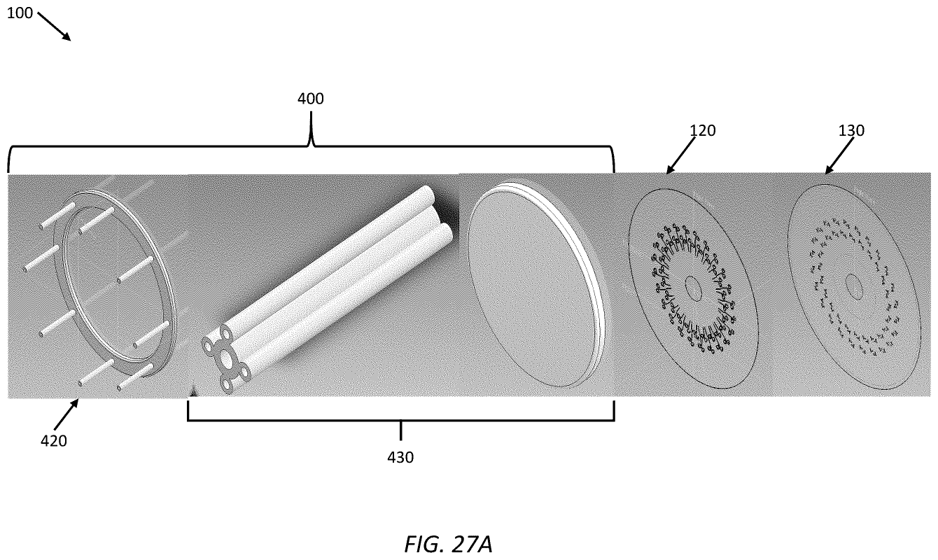

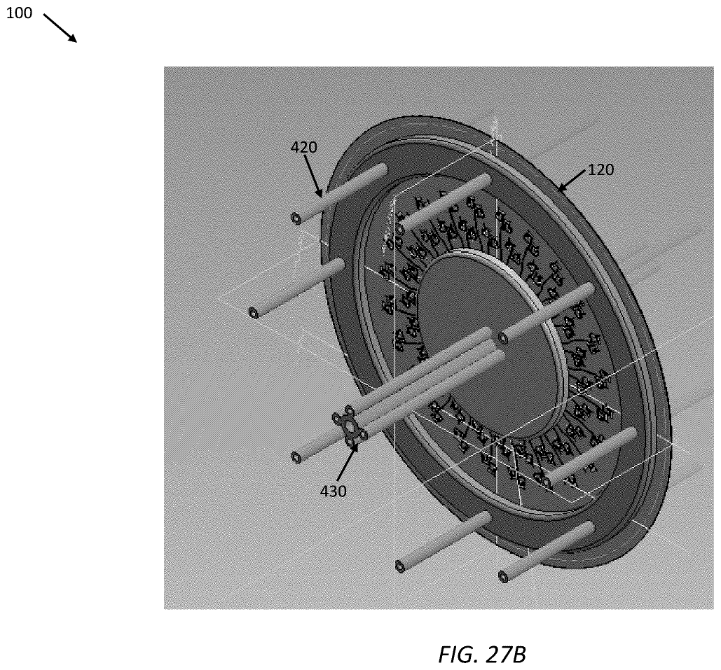

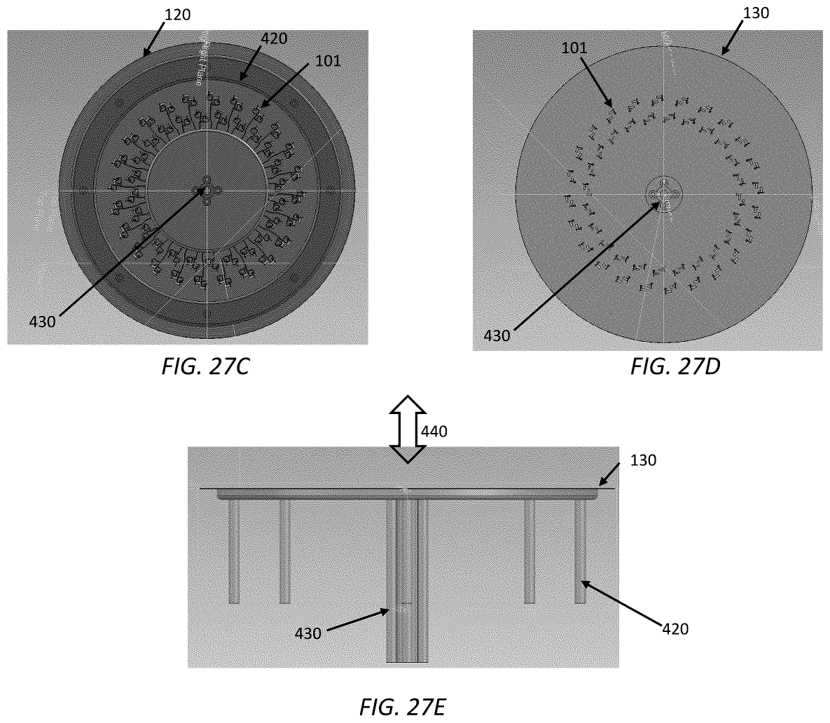

FIG. 27A illustrates an exploded view through a schematic representation of a disc-shaped microfluidic chip 100 having m×n (m>1, n>1) layout of particle processing units 101 according to the present disclosure. FIG. 27B illustrates an isometric view of the disc-shape microfluidic chip 100 of FIG. 27A. FIG. 27C illustrates a front view of the disc-shape microfluidic chip 100 of FIG. 27A. FIG. 27D illustrates a back view of the disc-shape microfluidic chip 100 of FIG. 27A. FIG. 27E illustrates a side view of the disc-shape microfluidic chip 100 of FIG. 27A.

As illustrated in FIGS. 27A-27E, the microfluidic chip 100 includes a fluid manifold 400 having an outlet manifold 420 and an inlet manifold 430, the particle focusing section 120, and the actuation section 130. The outlet manifold 420 can direct particles from the actuation section 130 to output reservoirs via the particle focusing section 120. The inlet manifold 430 can direct sample fluid and/or sheath fluid into the actuation section 130 via the particle focusing section 120. The actuation section 130 includes multiple actuation subsections, such as m×n actuation subsections. In some embodiments, the actuation section 130 includes multiple focusing subsections, such as m×n focusing subsections or regions as described herein. Each actuation subsection is used for a particular particle processing unit 101. As illustrated in FIG. 27E, the microfluidic chip 100 can be illuminated and/or detected in an illumination/detection direction 440 to illuminate and/or detect particles in the actuation section 130, for example, an interrogation region or regions of the actuation section 130.

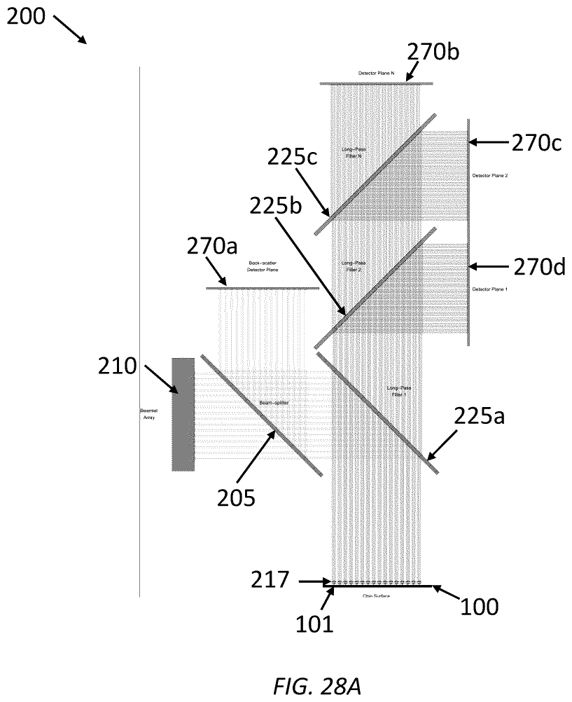

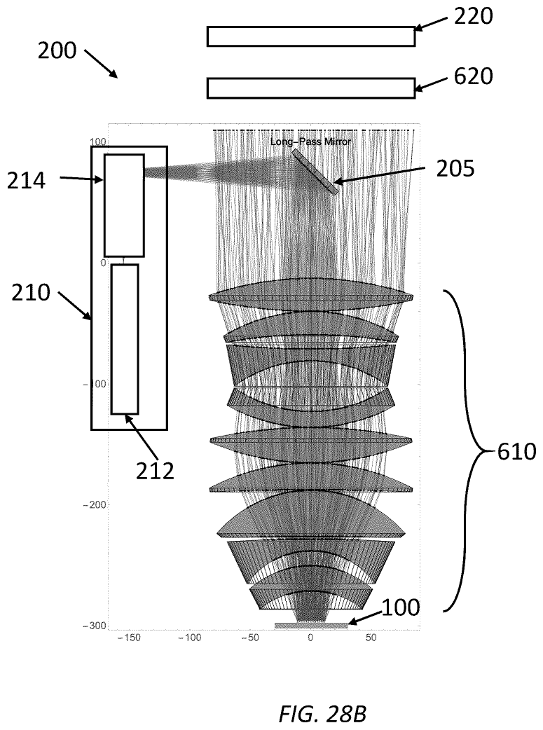

FIGS. 28A-28B illustrate various embodiments of an illumination systems and detection systems for simultaneous illumination and detection according to the present disclosure. Each embodiment of the illumination systems and detection systems presented in FIGS. 28A-28B includes an electromagnetic source system 210, a detection system 220, one or more light separation systems 205, and other related optical elements. Examples of the electromagnetic source system 210, the detection system 220, and light separation systems 205 are described above with respect to FIGS. 11-14E. In some embodiments, the detection system 220 can include one or more silicon photomultiplier arrays, multi-pixel photon counter (MPPC) arrays, a multianode photomultiplier tube assembly, and/or other suitable detector array. Examples of the microfluidic chip 100 are described above with respect to at least FIGS. 1-10, and 18-27.

In some embodiments, the particle processing system 200 provides ultra-high throughput particle processing in part by using wide-field illumination in an epi-illumination manner to illuminate multiple particle processing units 101 simultaneously and/or detect signals from the particle processing units 101 simultaneously. For example, as illustrated in FIG. 28A, the electromagnetic source system 210 illuminates multiple particle processing units 101 (e.g., interrogation regions in each of multiple microchannels of each particle processing unit 101) in the microfluidic chip 100 simultaneously. A light separation system 205 is used to direct illumination light to illuminate each particle processing unit 101 in the microfluidic chip 100. In some embodiments, the light separation system 205 is also used to direct back-scattering light from the particle processing units 101 to a detection plane 270a via an optical filter 225a. Scattering light (e.g., back, side, forward scattering light) and light emitted from particles from each particle processing unit 101 are detected by detector planes 270b-270d, respectively via optical filters 225b and 225c. It should be understood that the particle processing system 200 can have more detector planes than the ones illustrated in FIG. 28A to detect scattering light (back scattering light, side forward scattering light, and/or other suitable scattering light) and light emitted from particles (e.g., auto fluorescence, fluorescence) at different wavelengths. As illustrated in FIG. 28B, the electromagnetic source system 210 includes a spatial light modulator (SLM) 214 and a light source 212. The SLM 214 transforms a single laser beam from the light source 212 into a two dimensional (2D) array of m×n beamlets that illuminates each particle processing unit 101 in the microfluidic chip 100 simultaneously. A single light separation system 205 is used to direct illumination light from the SLM 214 to illuminate each particle processing unit 101 in the microfluidic chip 100. A first lens assembly 610 collects and directs light that has been emitted or scattered from particles in each processing unit 101 to the detection system 220 via a second lens assembly 620 that collects light that has been emitted or scattered from particles in each particle processing unit 101 and direct light from each particle processing unit 101 to a corresponding detection spot of the detection system 220. The detection system 220 receives and processes light that has been emitted or scattered from particles in each particle processing unit 101 simultaneously.

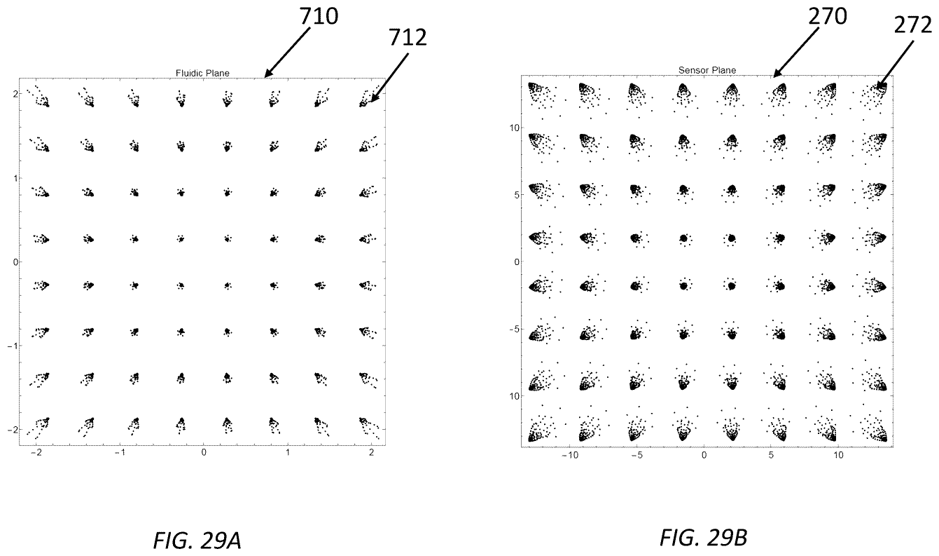

FIG. 29A illustrates a fluidic plane 710 of a particle processing system 200. The fluidic plane 710 includes 8×8 illumination spots 712. Each illumination spot 712 is focused on each particle processing unit 101 (e.g., an interrogation region 113).

FIG. 29B illustrates a detector plane 270 of a particle processing system 200. The detector plane 270 includes 8×8 detection spots 272. Each detection spot 272 detects scattering light and/or light emitted from each particle processing unit 101. It should be understood that a particle detection system can have more than 8×8 illumination spots and 8×8 detection spots as illustrated.

As can be understood from the foregoing, the concepts of the present disclosure may be embodied in a variety of ways. As such, embodiments or elements disclosed by the description or shown in the figures accompanying this application are not intended to be limiting, but rather illustrative of the numerous and varied embodiments generically encompassed by the present disclosure or equivalents encompassed with respect to any particular element thereof. In addition, the specific description of an embodiment or element may not explicitly describe all embodiments or elements possible; many alternatives are implicitly disclosed by the description and figures.

Unless defined otherwise, all technical and scientific terms used herein have the same meaning as commonly understood by one of ordinary skill in the art to which this disclosure belongs. It is also to be understood that the terminology used herein is for the purpose of describing particular embodiments, and is not intended to be limiting.

As will be apparent to those of skill in the art upon reading this disclosure, each of the embodiments described and illustrated herein have discrete components and features that may be readily separated from or combined with the features of any of the other embodiments without departing from the scope or spirit of the present disclosure. Any recited method can be carried out in the order of events recited or in any other order that is logically possible.

All numeric values herein are assumed to be modified by the term “about”, whether or not explicitly indicated. For the purposes of the present disclosure, ranges may be expressed as from “about” one particular value to “about” another particular value. It will be understood that the endpoints of each of the ranges are significant both in relation to the other endpoint, and independently of the other endpoint. When a value is expressed as an approximation by use of the antecedent “about,” it will be understood that the particular value forms another embodiment.

1. A microfluidic chip, comprising:
a plurality of sections that are stacked or layered in a stacking direction to form a plurality of microchannels at least partially oriented to flow along a stacking direction, the plurality of sections including:
a transfer section for introduction of sample fluid including particles;
and
a second section including a measurement section or the measurement section and an actuation section including a plurality of interrogation regions, each of the plurality of interrogation regions is associated with at least one microchannel in the plurality of microchannels.

2. The microfluidic chip of claim 1, wherein the plurality of sections further comprise a particle focusing section configured to focus the particles in the sample fluid.

3. The microfluidic chip of claim 2, wherein the particle focusing section includes a plurality of nozzles to combine sample fluid with sheath fluid.

4. The microfluidic chip of claim 1, wherein the actuation section comprises a plurality of actuators.

5. The microfluidic chip of claim 4, wherein each of the plurality of actuators include an interdigital transducer that generates a surface acoustic wave to deflect particles within the microfluidic channel.

6. The microfluidic chip of claim 5, wherein the actuation section further comprises one or more acoustic attenuation elements to acoustically isolate the actuators.

7. The microfluidic chip of claim 1, wherein the actuation section comprises a plurality of particle focusing regions.

8. The microfluidic chip of claim 1, wherein the actuation section includes a cover layer configured to provide optical access along the stacking direction to the plurality of interrogation regions.

9. The microfluidic chip of claim 1, further comprising a plurality of guide elements to align the sections along the stacking direction.

10. The microfluidic chip of claim 1, wherein an areal density of the plurality of interrogation regions is in a range from 1 to 500 regions per cm².

11. The microfluidic chip of claim 1, wherein the flow of particles in each microchannel is predominantly along the stacking direction in the respective interrogation region.

12. The microfluidic chip of claim 11, wherein the flow of particles transitions from a predominantly vertical direction to a horizontal direction for focusing.

13. The microfluidic chip of claim 11, wherein the flow of particles transitions from a predominantly vertical direction to a horizontal direction for interrogation.

14. The microfluidic chip of claim 1, wherein at least some of the plurality of sections are separable from one another.

15. The microfluidic chip of claim 14, wherein at least one section in the plurality of sections is swappable based upon a desired outcome or based on a characteristic of the population of particles to be processed by the microfluidic chip.

16. The microfluidic chip of claim 1, wherein the plurality of sections are permanently attached or fused to one another.

17. The microfluidic chip of claim 1, wherein the transfer section includes a sample input port and a sheath input port, the transfer section conveying sample fluid from the sample input port and sheath fluid from the sheath input port to the plurality of microchannels.

18. The microfluidic chip of claim 1, wherein the transfer section includes a first outlet port to enable extraction of desired particles from the chip and a second outlet port to enable extraction of undesired particles from the chip.

19. The microfluidic chip of claim 1, wherein the actuation section further comprises a plurality of pressure pulse dampeners, each pressure pulse dampener disposed along an associated microfluidic channel opposite a respective actuator.

20. A particle processing system, comprising
a microfluidic chip including a plurality of sections that are stacked or layered in a stacking direction to form a plurality of microchannels at least partially oriented to flow along the stacking direction, the plurality of sections including:
a transfer section for introduction of sample fluid including particles,
and
a second section including a measurement section or the measurement section and an actuation section including a plurality of interrogation regions, each of the plurality of interrogation regions is associated with at least one microchannel in the plurality of microchannels;
an electromagnetic source system to illuminate the plurality of interrogation regions;
a detection system to receive light from the plurality of interrogation regions; and
a computing system operably connected to the detection system and the actuation section of the microfluidic chip, the computing system configured to control actuation of the plurality of particle deflectors based upon signals received from the detection system.

21. The particle processing system of claim 20, wherein the plurality of sections further comprise a particle focusing section configured to focus the particles in the sample fluid.

22. The particle processing system of claim 21, wherein the particle focusing section includes a plurality of nozzles to combine sample fluid with sheath fluid.

23. The particle processing system of claim 20, wherein the actuation section comprises a plurality of actuators.

24. The particle processing system of claim 23, wherein each of the plurality of actuators include an interdigital transducer that generates a surface acoustic wave to deflect particles within the microfluidic channel.

25. The particle processing system of claim 24, wherein the actuation section further comprises one or more acoustic attenuation elements to acoustically isolate the actuators.

26. The particle processing system of claim 20, wherein the actuation section comprises a plurality of particle focusing regions.

27. The particle processing system of claim 20, wherein the electromagnetic source system comprises a plurality of vertical-cavity surface emitting lasers (VCSEL).

28. The particle processing system of claim 15, further comprising a light separation system.

29. The particle processing system of claim 20, wherein the detection system comprises a microlens array and a detector, each microlens in the microlens array collecting light from a respective interrogation region in the plurality of interrogation regions and delivering the light to the detector.

30. The particle processing system of claim 20, wherein the actuation section includes a cover layer configured to provide optical access along the stacking direction to the plurality of interrogation regions.

31. The particle processing system of claim 20, further comprising a plurality of guide elements to align the sections along the stacking direction.

32. The particle processing system of claim 20, wherein an areal density of the plurality of interrogation regions is in a range from 1 to 500 regions per cm².

33. The particle processing system of claim 20, wherein the flow of particles in each microchannel is predominantly perpendicular to the stacking direction in the respective interrogation region.

34. The particle processing system of claim 20, wherein at least some of the plurality of sections are separable from one another.

35. The particle processing system of claim 34, wherein at least one section in the plurality of sections is swappable based upon a desired outcome or based on a characteristic of the population of particles to be processed by the microfluidic chip.

36. The particle processing system of claim 20, wherein the plurality of sections are permanently attached or fused to one another.

37. The particle processing system of claim 20, wherein the transfer section includes a sample input port and a sheath input port, the transfer section conveying sample fluid from the sample input port and sheath fluid from the sheath input port to the plurality of microchannels.

38. The particle processing system of claim 20, wherein the transfer section includes a first outlet port to enable extraction of desired particles from the chip and a second outlet port to enable extraction of undesired particles from the chip.

39. The particle processing system of claim 20, wherein the actuation section further comprises a plurality of pressure pulse dampeners, each pressure pulse dampener disposed along an associated microfluidic channel opposite a respective actuator.

40. A method of assembling a microfluidic chip, comprising:
aligning a transfer section with a plurality of alignment holes in a focusing section using a plurality of alignment posts;
bonding the transfer section to the focusing section;
aligning a second section including a measurement section, or the measurement section and an actuation section, to the focusing section by aligning a plurality of alignment holes in the actuation section to the alignment posts; and
bonding the second section to the focusing section.

41. A method of sorting particles using a microfluidic chip, comprising:
flowing a sample stream including particles through a plurality of microchannels formed by a plurality of sections that are stacked or layered in a stacking direction to form the microfluidic chip, the plurality of microchannels at least partially oriented to flow along the stacking direction;
focusing particles in each of the plurality of microchannels using a focusing section of the plurality of sections;
detecting particle characteristics of particles flowing through a plurality of interrogation regions in an actuation section of the plurality of sections, each interrogation region associated with a microchannel; and
in response to the detected particle characteristics, sorting the particles using an actuator associated with each microchannel.
